(19) United States
(12) Patent Application Publication
(10) Pub. No.: US 2024/0393627 A1
(43) Pub. Date: Nov. 28, 2024

(54) VIEWING ANGLE CONTROLLER, DISPLAY PANEL, AND DISPLAY DEVICE COMPRISING THE SAME

(71) Applicant: SHANGHAI TIANMA MICRO-ELECTRONICS CO., LTD., Shanghai (CN)

(72) Inventors: Haili HAO, Shanghai (CN); Xintong LING, Shanghai (CN); Zhiyuan ZHANG, Shanghai (CN); Fan TIAN, Shanghai (CN)

(21) Appl. No.: 18/791,330

(22) Filed: Jul. 31, 2024

(30) Foreign Application Priority Data
Aug. 4, 2023 (CN) 202310982122.4

(51) Int. Cl. G02F 1/13; G02F 1/1335; G02F 1/13363; G02F 1/1337; G02F 1/1343

(52) U.S. Cl. CPC G02F 1/1323; G02F 1/133531; G02F 1/13363; G02F 1/1337; G02F 1/134309

(57) ABSTRACT

A viewing angle controller, a display panel, and a display device. The viewing angle controller includes at least one liquid crystal controlling box. The liquid crystal controlling box includes a first liquid crystal controlling box including a first substrate, a second substrate, and a first liquid crystal layer arranged between the first substrate and the second substrate. The first liquid crystal controlling box operates in a first state or in a second state. A transmittance of first light passing through the first liquid crystal controlling box in the second state is lower than one or both of a transmittance of the first light in the first state and a transmittance of second light passing through the first liquid crystal controlling box in the second state. An inclination of the first light is greater than that of the second light relative to the front-viewing direction of the viewing angle controller.

This application claims priority to Chinese Patent Application No. 202310982122.4, titled “VIEWING ANGLE CONTROLLER, DISPLAY PANEL, AND DISPLAY DEVICE COMPRISING THE SAME”, filed on Aug. 4, 2023 with the China National Intellectual Property Administration, which is incorporated herein by reference in its entirety.

### FIELD

The present disclosure relates to the field of display technology, and in particular to a viewing angle controller, a display panel, and a display device including the same.

### BACKGROUND

When a display device is used by a user in a specific scenario, a viewing angle range of the display panel needs to be controlled. For example, it is necessary to prevent others from peeking at the display device at a large viewing angle. For another example, a driver, a front-seat passenger, and rear-seat passengers need to view the vehicle-mounted display device at different viewing angles. On the basis of the above requirements, a viewing angle controller is generally provided in the display device. However, the viewing angle controller usually controls the viewing angle within a certain range centered on a front viewing angle, and fails to control the viewing angle of a certain direction separately.

### SUMMARY

A viewing angle controller, a display panel, and a display device are provided according to embodiments of the present disclosure. The display of the display panel in the viewing angle of a certain direction can be controlled separately while ensuring a normal display in the viewing angles of other directions.

In one embodiment, a viewing angle controller is provided according to an embodiment of the present disclosure. The viewing angle controller includes at least one liquid crystal controlling box, where the at least one liquid crystal controlling box includes a first liquid crystal controlling box, the first liquid crystal controlling box includes: a first substrate; a second substrate, arranged opposite to the first substrate; and a first liquid crystal layer, arranged between the first substrate and the second substrate, where: the first liquid crystal controlling box is configured to operate in a first state or in a second state; and a transmittance of the first liquid crystal controlling box with respect to a first light in the second state is less than one or both of: a transmittance of the first liquid crystal controlling box with respect to the first light in the first state, and a transmittance of the first liquid crystal controlling box with respect to a second light in the second state; where an incident angle of the first light at a surface of the first liquid crystal controlling box is greater than an incident angle of the second light at the surface of the first liquid crystal controlling box.

In one embodiment, a display panel is provided according to an embodiment of the present disclosure. The display panel includes a viewing angle controller, which is the viewing angle controller according to the embodiments of the present disclosure.

In one embodiment, a display device is provided according to an embodiment of the present disclosure. The display device includes the display panel according to the embodiment of the present disclosure.

In the viewing angle controller according to embodiments of the present disclosure, the liquid crystal controlling box is configured to control a range of a viewing angle. For the first light and the second light, an incident angle of the first light at a surface of the first liquid crystal controlling box is greater than an incident angle of the second light at the surface of the first liquid crystal controlling box. When the transmittance of the first liquid crystal controlling box with respect to the first light in the first state is greater than the transmittance of the first liquid crystal controlling box with respect to the first light in the second state, the transmittance of the first liquid crystal controlling box with respect to the first light in the second state may be reduced, and it is difficult for the light to pass through the liquid crystal controlling box and emit at a large angle, and the range of the viewing angle is reduced. When the first liquid crystal controlling box is in the second state, the transmittance of the first light is less than the transmittance of the second light, and it is difficult for the first light with a large inclination to pass through the liquid crystal controlling box and emit at a large angle, while the second light with a small inclination can be emitted at a small angle after passing through the first liquid crystal controlling box. Therefore, the impact on the viewing angle in other directions is not obvious while controlling the viewing angle in one direction.

### BRIEF DESCRIPTION OF THE DRAWINGS

In order to clarity illustration of the embodiments of the present disclosure, hereinafter the drawings to be applied in embodiments of the present disclosure are briefly described. Apparently, the drawings in the following descriptions are only some embodiments of the present disclosure.

FIG. 1 is a schematic diagram of an optical path in a viewing angle controller in a first state according to an embodiment of the present disclosure.

FIG. 2 is a schematic diagram of an optical path in a viewing angle controller in a second state according to an embodiment of the present disclosure.

FIG. 3 is a schematic structural diagram of a viewing angle controller according to an embodiment of the present disclosure.

FIG. 4 is a schematic structural diagram of a viewing angle controller in a first state according to an embodiment of the present disclosure.

FIG. 5 is a schematic structural diagram of a viewing angle controller in a second state according to an embodiment of the present disclosure.

FIG. 6 is a schematic structural diagram of a viewing angle controller in a first state according to another embodiment of the present disclosure.

FIG. 7 is a schematic structural diagram of a viewing angle controller in a first state according to another embodiment of the present disclosure.

FIG. 8 is a schematic structural diagram of a viewing angle controller in a first state according to another embodiment of the present disclosure.

FIG. 9 is a schematic structural diagram of a viewing angle controller in a second state according to another embodiment of the present disclosure.

FIG. 10 is a schematic structural diagram of a viewing angle controller in a first state according to another embodiment of the present disclosure.

FIG. 11 is a schematic structural diagram of a viewing angle controller in a second state according to another embodiment of the present disclosure.

FIG. 12 is a structural schematic diagram illustrating alignment directions and polarization directions in a viewing angle controller in a direction perpendicular to a plane where a first liquid crystal layer is located according to an embodiment of the present disclosure.

FIG. 13 is a schematic diagram of an optical path in a viewing angle controller in a second state according to an embodiment of the present disclosure.

FIG. 14 is a schematic structural diagram of a viewing angle controller according to another embodiment of the present disclosure.

FIG. 15 is a schematic structural diagram of a viewing angle controller according to another embodiment of the present disclosure.

FIG. 16 is a schematic structural diagram of a viewing angle controller according to another embodiment of the present disclosure.

FIG. 17 is a schematic structural diagram of a viewing angle controller according to another embodiment of the present disclosure.

FIG. 18 is a schematic structural diagram of a viewing angle controller according to another embodiment of the present disclosure.

FIG. 19 is a schematic structural diagram of a viewing angle controller according to another embodiment of the present disclosure.

FIG. 20 is a schematic structural diagram of a viewing angle controller according to another embodiment of the present disclosure.

FIG. 21 is a schematic structural diagram of a viewing angle controller according to another embodiment of the present disclosure.

FIG. 22 is a schematic diagram of an optical path in a second liquid crystal controlling box of a viewing angle controller in a third state according to an embodiment of the present disclosure.

FIG. 23 is a schematic diagram of an optical path in a second liquid crystal controlling box of a viewing angle controller in a fourth state according to an embodiment of the present disclosure.

FIG. 24 is a schematic structural diagram of a second liquid crystal controlling box of a viewing angle controller according to an embodiment of the present disclosure.

FIG. 25 is a schematic structural diagram of a second liquid crystal controlling box of a viewing angle controller according to another embodiment of the present disclosure.

FIG. 26 is a schematic structural diagram of a second liquid crystal controlling box of a viewing angle controller in a third state according to an embodiment of the present disclosure.

FIG. 27 is a schematic structural diagram of a second liquid crystal controlling box of a viewing angle controller in a fourth state according to an embodiment of the present disclosure.

FIG. 28 is a schematic structural diagram illustrating alignment directions and polarization directions in a second liquid crystal controlling box of a viewing angle controller in a direction perpendicular to a plane where a second liquid crystal layer is located according to an embodiment of the present disclosure.

FIG. 29 is a schematic diagram of an optical path in a second liquid crystal controlling box of a viewing angle controller in a fourth state according to another embodiment of the present disclosure.

FIG. 30 is a schematic diagram of an optical path in a viewing angle controller where a first liquid crystal controlling box is in a second state and a second liquid crystal controlling box is in a fourth state according to an embodiment of the present disclosure.

FIG. 31 is a schematic diagram of an optical path in a viewing angle controller where a first liquid crystal controlling box is in a second state and a second liquid crystal controlling box is in a fourth state according to another embodiment of the present disclosure.

FIG. 32 is a schematic structural diagram of a display panel according to an embodiment of the present disclosure.

FIG. 33 is a schematic structural diagram of a display panel according to another embodiment of the present disclosure.

FIG. 34 is a schematic structural diagram of a display panel according to another embodiment of the present disclosure.

FIG. 35 is a schematic structural diagram of a display panel according to another embodiment of the present disclosure.

FIG. 36 is a schematic structural diagram of a display panel according to another embodiment of the present disclosure.

FIG. 37 is a schematic structural diagram of a display panel according to another embodiment of the present disclosure.

FIG. 38 is a schematic structural diagram of a display panel according to another embodiment of the present disclosure.

FIG. 39 is a schematic structural diagram of a display panel according to another embodiment of the present disclosure.

FIG. 40 is a schematic structural diagram of a display panel according to another embodiment of the present disclosure.

FIG. 41 is a schematic structural diagram of a display device according to an embodiment of the present disclosure.

Reference numerals:

| | |
|---|---|
| 1: first liquid crystal controlling box; | 11: first substrate; |
| 12: second substrate; | 13: first liquid crystal layer; |
| 131: liquid crystal molecule; | 14: first alignment film; |
| 15: second alignment film; | 16: first electrode; |
| 161: first sub-electrode; | 162: third sub-electrode; |
| 163: fourth sub-electrode; | 17: second electrode; |
| 171: second sub-electrode; | 172: fifth sub-electrode; |
| 173: sixth sub-electrode; | 2: first polarizer; |
| 3: second polarizer; | 4: second liquid crystal |
| | controlling box; |
| 41: third substrate; | 42: fourth substrate; |
| 43: second liquid crystal layer; | 44: third alignment film; |
| 45: fourth alignment film; | 46: third electrode; |
| 47: fourth electrode; | 5: third polarizer; |
| L1: first light; | L2: second light; |
| L3: third light; | L4: fourth light; |
| A1: first direction; | A2: second direction; |
| F: front-view direction; | C1: first alignment direction; |
| C2: second alignment direction; | C3: third alignment direction; |
| C4: fourth alignment direction; | P1: first polarization direction; |
| P2: second polarization direction; | P3: third polarization direction; |
| S1: first region; | S2: second region; |
| 100: display device; | 200: display panel; |
| 210: light-emitting device layer; | 22: substrate; |
| 230: array layer; | 240: backlight layer; |
| 250: liquid crystal display box; | 260: pixel unit; |
| 261: first pixel unit; | 262: second pixel unit; |
| 270: pixel electrode layer. | |

### DETAILED DESCRIPTION

Hereinafter features and exemplary embodiments of the present disclosure are described in detail. In the following detailed description, many specific details are provided to fully understand the present disclosure. The present disclosure may be implemented without some of these specific details. The following description of the embodiments is only intended to provide a better understanding for the present disclosure by illustrating the embodiments of the present disclosure.

It should be noted that the embodiments of the present disclosure and features in the embodiments may be combined with each other without conflict. The embodiments of the present disclosure are described in detail below in conjunction with the drawings.

Relationship terms such as “first”, “second” and the like are only used herein to distinguish one entity or operation from another, rather than to necessitate or imply that an actual relationship or order exists between the entities or operations. Furthermore, the terms such as “include”, “comprise” or any other variants thereof means to be non-exclusive. Therefore, a process, a method, an article or a device including a series of elements include not only the disclosed elements but also other elements that are not clearly enumerated, or further include inherent elements of the process, the method, the article or the device. Unless expressively limited, the statement “including . . . ” does not exclude the case that other similar elements may exist in the process, the method, the article or the device other than enumerated elements.

When describing a structure of components, one layer or region being “on” or “over” another layer or region may indicate that the former is directly on the latter or there is a third layer or region between the two, and that the former may be “under” or “below” the latter in a case that the structure is flipped.

In addition, the term “and/or” describes a relationship between associated objects and indicates three possible relationships. For example, “A and/or B” may refer to that there is only A, there are both A and B, and there is only B. In addition, the symbol “/” usually indicates an “or” relationship between the associated objects.

It should be understood that in the embodiment of the present disclosure, “B corresponding to A” indicates that B is associated with A, and B may be determined based on A. Further, it should be understood that determining B based on A does not indicate that B is only determined based on A, and B may further be determined based on A and/or other information.

It is found that when a display device is applied, viewing a screen displayed by a display device at a large viewing angle is not allowed in some cases. For example, people around the user are prevented from peeking at the screen displayed on the display device at a large viewing angle. A viewing angle controller is generally provided in the display device, and the light from the display device is difficult to be emitted at a large angle, and the viewing angle of the display device is within a small range centered on a front-viewing angle. However, in other cases, it is necessary to enable the display device to limit the range of the viewing angle in only a certain direction. For example, when a front-seat passenger in a vehicle views a vehicle-mounted display screen, an inclined viewing angle at a side of the vehicle-mounted display screen is limited without limiting another inclined viewing angle at the other side, in order to prevent the display screen from distracting a driver in a driving seat. The conventional viewing angle controller in the display device simultaneously limit viewing angles at both sides, the viewing angle in a certain direction is difficult to be limited separately.

In view of the above issues, a viewing angle controller, a display panel, and a display device are provided according to the present disclosure. The viewing angle controller includes a liquid crystal controlling box. The liquid crystal controlling box includes a first liquid crystal controlling box. The first liquid crystal controlling box includes a first substrate, a second substrate, and a first liquid crystal layer. The first liquid crystal controlling box is configured to operate in a first state or in a second state. For a first light inclining relative to a front-viewing direction, the transmittance of the first liquid crystal controlling box with respect to the first light in the first state is greater than the transmittance of the first liquid crystal controlling box with respect to the first light in the second state, and the first liquid crystal controlling box in the second state can restrict the inclined light from passing through the first liquid crystal controlling box, and a large inclined viewing angle is limited. For the first light and second light with a smaller inclination than the first light, when passing through the first liquid crystal controlling box in the second state, the transmittance of the first light is smaller than the transmittance of the second light. The light with a large inclination is difficult to pass through the first liquid crystal controlling box, while the light with a small inclination can still pass through the first liquid crystal controlling box. In one embodiment, a large inclined viewing angle in a certain direction is limited, and the impact on viewing angles in other directions is not obvious.

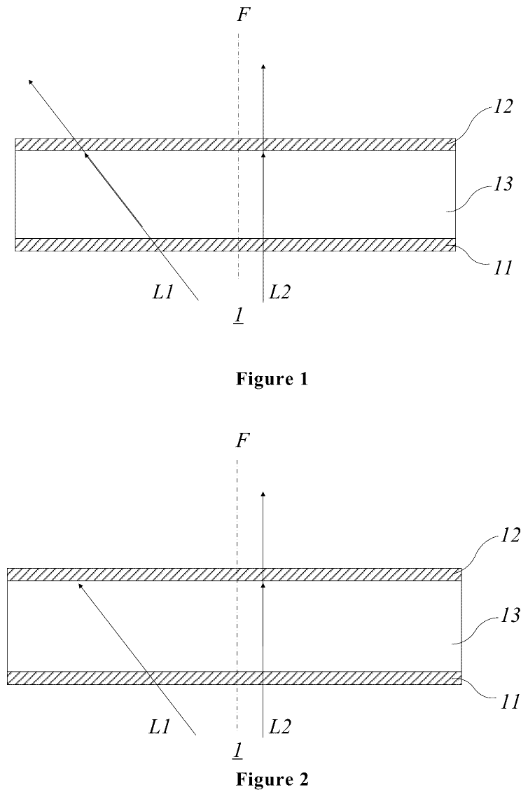

FIG. 1 is a schematic diagram of an optical path in a viewing angle controller in a first state according to an embodiment of the present disclosure. FIG. 2 is a schematic diagram of an optical path in a viewing angle controller in a second state according to an embodiment of the present disclosure.

Reference is made in FIGS. 1 and 2, a viewing angle controller is provided according to an embodiment of the present disclosure. The viewing angle controller includes at least one liquid crystal controlling box. The liquid crystal controlling box includes a first liquid crystal controlling box 1. The first liquid crystal controlling box 1 includes a first substrate 11 and a second substrate 12 that are arranged opposite to each other, and a first liquid crystal layer 13 located between the first substrate 11 and the second substrate 12. The first liquid crystal controlling box 1 is configured to operate in a first state or in a second state. The transmittance of the first liquid crystal controlling box 1 with respect to the first light L1 in the second state is smaller than one or both of the transmittance of the first liquid crystal controlling box 1 with respect to the first light L1 in the first state and the transmittance of the first liquid crystal controlling box 1 with respect to the second light L2 in the second state. An inclination of the first light L1 relative to the front-viewing direction F of the viewing angle controller is greater than an inclination of the second light L2 relative to the front-viewing direction F of the viewing angle controller. Herein an inclination of the light relative to the front-viewing direction F of the viewing angle controller may be regarded as an incident angle of the light at a surface of the first liquid crystal controlling box. That is, an incident angle of the first light L1 at the surface of the first liquid crystal controlling box is greater than an incident angle of the second light L2 at the surface of the first liquid crystal controlling box.

The viewing angle controller according to the embodiment of the present disclosure is configured to control a range of the viewing angle of the display panel. The viewing angle controller according to the embodiment of the present disclosure controls the range of the viewing angle through limiting the transmission of light. The number of the liquid crystal controlling box in the embodiment of the present disclosure may be at least one. The liquid crystal controlling box includes at least one first liquid crystal controlling box 1.

The first substrate 11 and the second substrate 12 are configured to form a box structure for the first liquid crystal controlling box 1, and the first liquid crystal layer 13 is accommodated in the box structure to form the first liquid crystal controlling box 1. The light may be incident from the first substrate 11 and irradiate towards the second substrate 12.

The first liquid crystal controlling box 1 is configured to operate in the first state or the second state. The first state is a state when the first liquid crystal controlling box 1 does not operate, and the second state is a state when the first liquid crystal controlling box 1 operates. Generally, the first liquid crystal controlling box 1 applies an electric field through an electrode and changes the state through changing the electric field. In a case that the electrode is not energized, the first liquid crystal layer 13 of the first liquid crystal controlling box 1 is not in the electric field, and the first liquid crystal controlling box 1 is in the first state, which indicates that the first liquid crystal controlling box 1 does not operate. In a case that the electrode is energized, the first liquid crystal layer 13 of the first liquid crystal controlling box 1 is in the electric field, and the first liquid crystal controlling box 1 is in the second state, which indicates that the first liquid crystal controlling box 1 operates. The front-viewing direction F is a direction perpendicular to a plane where the first substrate 11 is located, which is equivalent to the front-viewing direction F being parallel to a normal line of incident light. For the convenience of description, the first light L1 and the second light L2 are configured to illustrate optical characteristics of the first liquid crystal controlling box 1 in different states. The inclination of the first light L1 relative to the front-viewing direction F of the viewing angle controller is greater than the inclination of the second light L2 relative to the front-viewing direction F of the viewing angle controller. Considering that the front-viewing direction F is parallel to the normal line of the incident light, the inclination of a certain light relative to the front-viewing direction F of the viewing angle controller indicates an incident angle of this light. A large inclination engenders a large incident angle. Therefore, the incident angle of the first light L1 is greater than the inclination of the second light L2.

The transmittance of the first liquid crystal controlling box 1 with respect to the first light L1 in the first state is greater than the transmittance of the first liquid crystal controlling box 1 with respect to the first light L1 in the second state. In the second state, liquid crystal of the first liquid crystal controlling box 1 is deflected at a certain angle in a direction perpendicular to the first liquid crystal controlling box 1, and the first light L1 is difficult to emit from the first liquid crystal controlling box 1 after the first light L1 is deflected, and the transmittance of the first light L1 that is incident and inclined is reduced. Therefore, the inclined first light is difficult to pass through the first liquid crystal controlling box 1. That is, the first liquid crystal controlling box 1 can limit the transmission of the inclined light during operation. When the viewing angle controller according to the embodiment of the present disclosure is applied to the display device, it is difficult to view the screen displayed on the display panel at a large viewing angle, achieving the purpose of preventing others from pecking at the display device.

The transmittance of the first liquid crystal controlling box 1 with respect to the first light L1 in the second state is lower than the transmittance of the first liquid crystal controlling box 1 with respect to the second light L2 in the second state. In the second state, the first liquid crystal controlling box 1 can limit the transmission of the light with a large inclination during operation. When the viewing angle controller according to the embodiment of the present disclosure is applied to the display device, it is difficult to view the screen displayed on the display panel at a large viewing angle, achieving the purpose of preventing others from peeking at the display device, while the screen displayed on the display panel at a small viewing angle can be viewed.

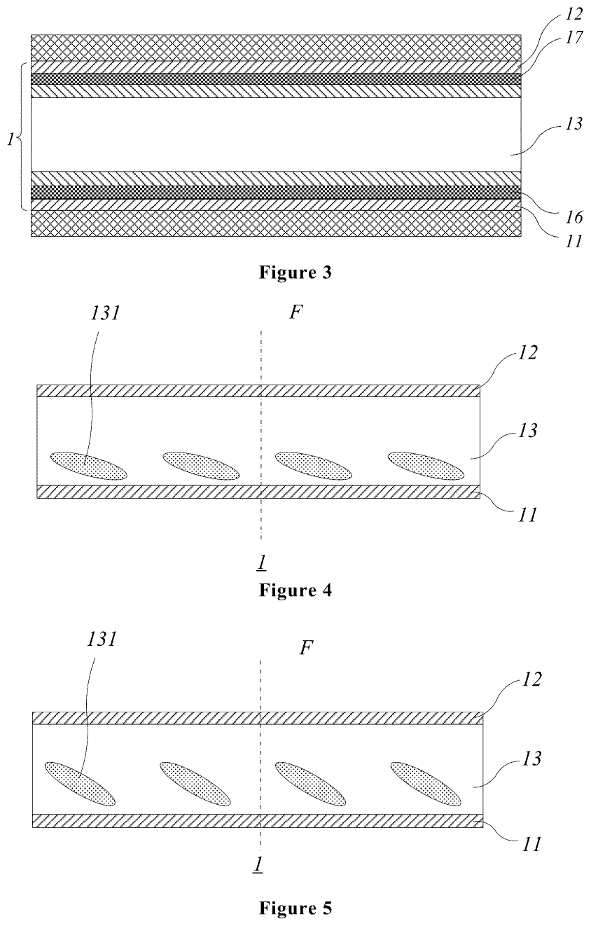

FIG. 3 is a schematic structural diagram of a viewing angle controller according to another embodiment of the present disclosure.

Furthermore, reference is made to FIG. 3, the first liquid crystal controlling box 1 further includes a first electrode 16 and a second electrode 17. The first electrode 16 is arranged between the first liquid crystal layer 13 and the first substrate 11. The second electrode 17 is arranged between the first liquid crystal layer 13 and the second substrate 12. In the second state, a voltage difference between the first electrode 16 and the second electrode 17 ranges from 1.5V to 4V.

In a case that the first liquid crystal controlling box 1 is in the first state, the voltage difference between the first electrode 16 and the second electrode 17 is 0V, and the first liquid crystal layer 13 is not in the electric field, which indicates that the first liquid crystal controlling box 1 does not operate, and the display panel displays normally. In a case that the first liquid crystal controlling box 1 is in the second state, the voltage difference between the first electrode 16 and the second electrode 17 ranges from 1.5V to 4V, and the first liquid crystal layer 13 is in the electric field, which indicates that the first liquid crystal controlling box 1 operates, and the display panel is in an anti-peeking state. FIG. 4 is a schematic structural diagram of a viewing angle controller in a first state according to an embodiment of the present disclosure. FIG. 5 is a schematic structural diagram of a viewing angle controller in a second state according to an embodiment of the present disclosure.

Furthermore, reference is made to FIGS. 4 and 5, with respect to a direction parallel to a surface of the viewing angle controller, an orientation deviation of long axes of liquid crystal molecules 131 in the first liquid crystal layer 13 in the first state is less than an orientation deviation of long axes of the liquid crystal molecules 131 in the first liquid crystal layer 13 in the second state.

The first substrate 11 of the first liquid crystal controlling box 1 is parallel to the second substrate 12 of the first liquid crystal controlling box 1, and the first liquid crystal controlling box 1 is a layered structure, which may be abstracted as a plate-type structure. The surface of the first liquid crystal controlling box 1 may be regarded as the plane where the viewing angle controller is located. The liquid crystal molecules 131 in the first liquid crystal layer 13 are elliptical. A long axis direction of the liquid crystal molecules 131 may represent a direction of the liquid crystal molecules 131. The orientation deviation of long axes of the liquid crystal molecules 131 with respect to the direction parallel to the surface of the viewing angle controller may be characterized by an acute angle formed by the long axis direction of the liquid crystal molecules 131 and the surface of the first liquid crystal controlling box 1. The orientation deviation of long axes of the liquid crystal molecules 131 in the first liquid crystal layer 13 in the first state is less than the orientation deviation of long axes of the liquid crystal molecules 131 in the first liquid crystal layer 13 in the second state. That is, in the first state, the direction of the liquid crystal molecules 131 forms a small acute angle with the surface of the first liquid crystal controlling box 1, while in the second state, the direction of the liquid crystal molecules 131 forms a large acute angle with the surface of the first liquid crystal controlling box 1. In a case that the first liquid crystal controlling box 1 is switched from the first state to the second state, the liquid crystal molecules 131 is rotated towards a direction perpendicular to the surface of the first liquid crystal controlling box 1. When the liquid crystal molecules 131 stops rotating, the direction of the liquid crystal molecules 131 is not necessarily perpendicular to the surface of the first liquid crystal controlling box 1.

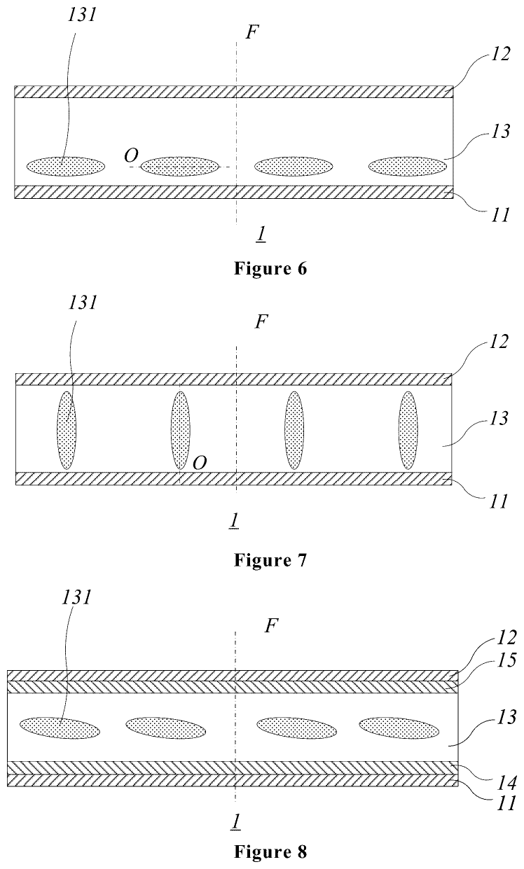

FIG. 6 is a schematic structural diagram of a viewing angle controller in a first state according to another embodiment of the present disclosure. FIG. 7 is a schematic structural diagram of a viewing angle controller in a first state according to another embodiment of the present disclosure.

Furthermore, reference is made to FIGS. 6 and 7, the first liquid crystal layer 13 includes the liquid crystal molecules 131. The liquid crystal molecules 131 have positive dielectric anisotropy. A long axis direction of the liquid crystal molecules 131 corresponds to a reference line O. The plane where the first liquid crystal layer 13 is located corresponds to a reference plane. In the first state, an angle between the reference line O and the reference plane ranges from 0° to 10°. In one embodiment, the liquid crystal molecules 131 have negative dielectric anisotropy. A long axis direction of the liquid crystal molecules 131 corresponds to a reference line O. The plane where the first liquid crystal layer 13 is located corresponds to a reference plane. In the first state, an angle between the reference line O and the reference plane ranges from 85° to 90°.

In an embodiment, during fabricating the first liquid crystal layer 13, the liquid crystal molecules 131 in the first liquid crystal layer 13 exhibit a preset inclination angle. The long axis direction of the liquid crystal molecules 131 corresponds to the reference line O, and the plane where the first liquid crystal layer 13 is located corresponds to the reference plane. The preset inclination angle is the angle between the reference line O and the reference plane. Reference is made to FIG. 6, in a case that the liquid crystal molecules 131 of the first liquid crystal layer 13 have positive dielectric anisotropy, in the first state, the angle between the reference line O and the reference plane ranges from 0° to 10°, and the liquid crystal molecules 131 are almost parallel to the reference plane. In a case that the first liquid crystal controlling box 1 is switched to be in the second state, the first liquid crystal layer 13 is in the electric field, and the liquid crystal molecules 131 are rotated towards the direction perpendicular to the reference plane under the action of the electric field. Reference is made to FIG. 7, in a case that the liquid crystal molecules 131 of the first liquid crystal layer 13 have negative dielectric anisotropy, in the first state, the angle between the reference line O and the reference plane ranges from 85° to 90°, and the liquid crystal molecules 131 are almost perpendicular to the reference plane. In a case that the first liquid crystal controlling box 1 is switched to be in the second state, the first liquid crystal layer 13 is in the electric field, and the liquid crystal molecules 131 are rotated towards a direction parallel to the reference plane under the action of the electric field.

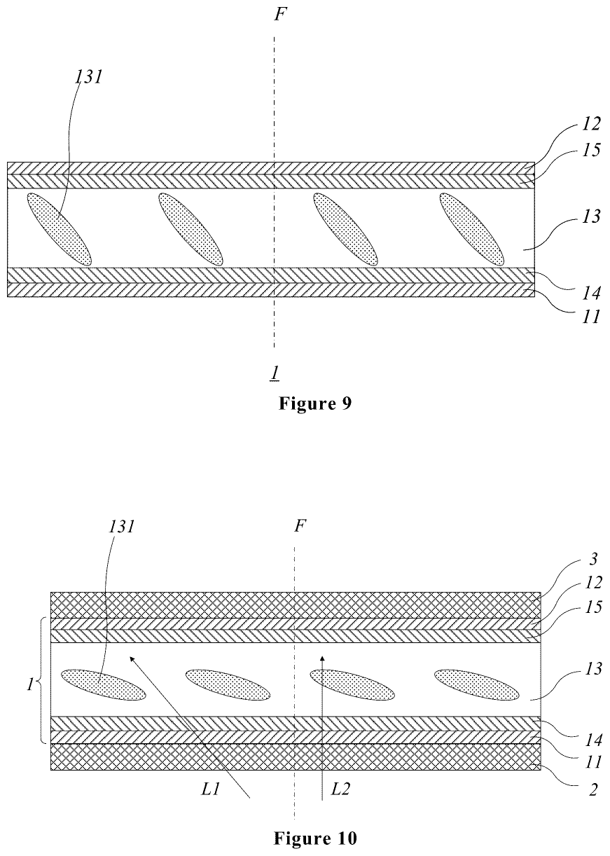

FIG. 8 is a schematic structural diagram of a viewing angle controller according to an embodiment of the present disclosure. FIG. 9 is a schematic structural diagram of a viewing angle controller according to another embodiment of the present disclosure.

Furthermore, reference is made to FIGS. 8 to 9, the first liquid crystal controlling box 1 includes a first alignment film 14 and a second alignment film 15. The first alignment film 14 is arranged on a side of the first liquid crystal layer 13 facing the first substrate 11, and has a first alignment direction C1. The second alignment film 15 is arranged on a side of the first liquid crystal layer 13 facing the second substrate 12, and has a second alignment direction C2. In the first state, the liquid crystal molecules 131 in the first liquid crystal layer 13 are rotated clockwise or counterclockwise from the first substrate 11 toward the second substrate 12.

In the direction from the first substrate 11 to the second substrate 12, at least a part of the liquid crystal molecules 131 in the first liquid crystal layer 13 may be arranged to be in multiple layers. Regardless of whether the first liquid crystal controlling box 1 is in the first state or in the second state, the liquid crystal molecules 131 in the multiple layers are arranged along a direction from the first alignment film 14 to the second alignment film 15. The first alignment film 14 is arranged on the side of the first liquid crystal layer 13 facing the first substrate 11. On the plane where the first substrate 11 is located, the long axis direction of the liquid crystal molecules 131 closest to the first alignment film 14 is parallel to the first alignment direction C1. The second alignment film 15 is arranged on the side of the first liquid crystal layer 13 facing the second substrate 12, and has the second alignment direction C2. In one embodiment, the first alignment direction C1 may be perpendicular to the second alignment direction C2. On the plane where the first substrate 11 is located, a long axis direction of an orthographic projection of the liquid crystal molecules 131 closest to the second alignment film 15 is parallel to the second alignment direction C2.

For example, the liquid crystal molecules 131 have positive dielectric anisotropy. In the first state, the first liquid crystal controlling box 1 is observed along the front-viewing direction F of the first liquid crystal controlling box 1, and the liquid crystal molecules 131 in different layers are gradually rotated clockwise or counterclockwise in the direction from the first substrate 11 to the second substrate 12. The first liquid crystal controlling box 1 is observed along the front-viewing direction F of the first liquid crystal controlling box 1 at a same position, the liquid crystal molecules 131 in different layers form projections on the plane where the first substrate 11 is located. Projections of centers of multiple liquid crystal molecules 131 arranged in different layers overlap at one point. The projections of the liquid crystal molecules 131 in different layers are gradually rotated clockwise or counterclockwise around the point in the direction from the first substrate 11 to the second substrate 12. On the plane where the first substrate 11 is located, the long axis direction of orthographic projections of multiple liquid crystal molecules 131 are gradually rotated in the direction from the first substrate 11 to the second substrate 12.

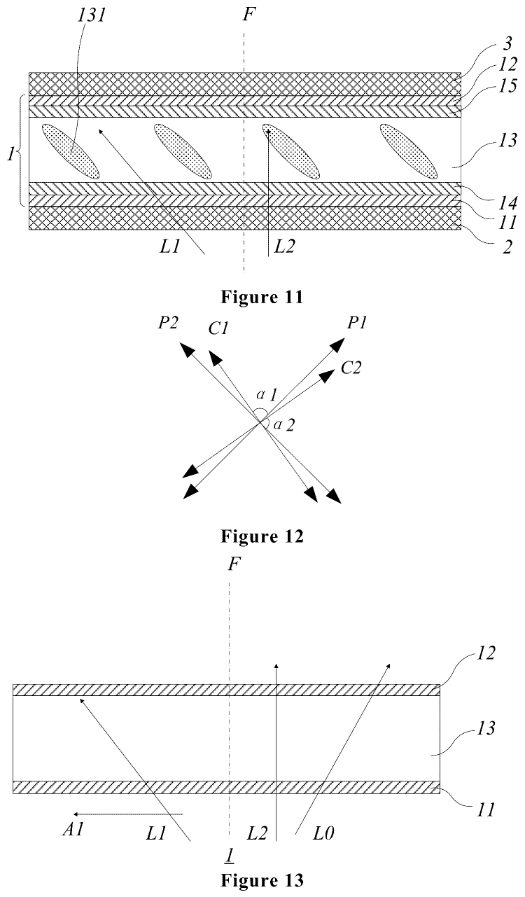

FIG. 10 is a schematic structural diagram of a viewing angle controller in a first state according to another embodiment of the present disclosure. FIG. 11 is a schematic structural diagram of a viewing angle controller in a second state according to another embodiment of the present disclosure. FIG. 12 is a structural schematic diagram illustrating alignment directions and polarization directions in a viewing angle controller in a direction perpendicular to the plane where a first liquid crystal layer is located according to an embodiment of the present disclosure.

Furthermore, reference is made to FIGS. 10 to 12, the viewing angle controller according to the embodiment of the present disclosure further includes: a first polarizer 2 and a second polarizer 3. The first polarizer 2 is arranged on a side of the first substrate 11 away from the first alignment film 14, and has a first polarization direction P1. The second polarizer 3 is arranged on a side of the second substrate 12 away from the second alignment film 15, and has a second polarization direction P2. The first polarization direction P1 is perpendicular to the second polarization direction P2. An angle α1 between the first polarization direction P1 and the first alignment direction C1 meets: 0°≤α1≤180°, and 0°≤|α1−k×90°|≤15°, where k may be 0, 1, or 2. An angle α2 between the second polarization direction P2 and the second alignment direction C2 meets: 0°≤α2≤180°, and 0°≤|α2−k×90°|≤15°, where k may be 0, 1, or 2.

The light is transmitted into the first liquid crystal controlling box 1 through the first polarizer 2, and forms polarized light along the first polarization direction P1. The polarized light is deflected by the first liquid crystal controlling box 1 to rotate the polarization direction. When the polarization direction is rotated to be parallel to the second polarization direction P2, the light may be transmitted from the second polarizer.

For the convenience of description, the liquid crystal molecules 131 have positive dielectric anisotropy herein. Reference is made to FIG. 10, in the first state, the long axis direction of the liquid crystal molecules 131 is almost parallel to the plane where the first substrate 11 is located. When the first light L1 and the second light L2 pass through the first polarizer 2, both the polarization direction of the first light L1 and the polarization direction of the second light L2 are parallel to the first polarization direction P1. When the first light L1 and the second light L2 are incident on the liquid crystal molecules 131, both the polarization direction of the first light L1 and the polarization direction of the second light L2 are deflected, and both a deflected polarization direction of the first light L1 and a deflected polarization direction of the second light L2 are parallel to the second polarization direction P2, and both the first light L1 and the second light L2 may be transmitted from the second polarizer 3. Reference is made to FIG. 11, in the second state, the liquid crystal molecules 131 are rotated at an angle. Before the liquid crystal molecules 131 are rotated, the long axis direction of the liquid crystal molecules 131 is almost parallel to the plane where the first substrate 11 is located, the liquid crystal molecules 131 are rotated from the direction parallel to the plane where the first substrate 11 is located towards the direction perpendicular to the plane where the first substrate 11 is located. After the liquid crystal molecules 131 are rotated, the long axis direction of the liquid crystal molecules 131 is inclined relative to the plane where the first substrate 11 is located to form an acute angle. When the first light L1 is incident on the liquid crystal molecules 131, an incident direction of the first light L1 is almost parallel to the long axis direction of the liquid crystal molecules 131 to form a relatively small acute angle. That is, the first light L1 is almost transmitted along the long axis direction of the liquid crystal molecule. Therefore, after the first light L1 is incident on the liquid crystal molecules 131, the polarization direction of the first light L1 is deflected, and the deflected polarization direction intersects with the second polarization direction P2 to form a relatively large acute angle, and it is difficult for the first light L1 to pass through the second polarizer 3. Therefore, the transmittance of the first light L1 in the second state is reduced. When the second light L2 is incident on the liquid crystal molecules 131, the incident direction of the second light L2 intersects with the long axis direction of the liquid crystal molecules 131 to form a relatively large acute angle. That is, the second light L2 is hardly transmitted along the long axis direction of the liquid crystal molecule. After the second light L2 is incident on the liquid crystal molecules 131, the polarization direction of the second light L2 is deflected, and the deflected polarization direction intersects with the second polarization direction P2 to form a relatively small acute angle, and the second light L2 is easily transmitted through the second polarizer 3. Therefore, the transmittance of the second light L2 in the second state is almost unchanged.

In one embodiment, the angle α1 formed by the first polarization direction P1 and the first alignment direction C1 meets: 0°≤α1≤180°, and 0°≤|α1−k×90°|≤15°, where k may be 0, 1, or 2. The angle α2 formed by the second polarization direction P2 and the second alignment direction C2 meets: 0°≤α2≤180°, and 0°≤|α2−k×90°|≤15°, where k may be 0, 1, or 2. That is, the first polarization direction P1 of the first polarizer 2 is perpendicular to or parallel to the first alignment direction C1, and an upper limit of a position error between the first polarization direction P1 and the first alignment direction C1 is 15°. Similarly, the second polarization direction P2 of the second polarizer 3 is perpendicular to or parallel to the second alignment direction C2, and an upper limit of a position error between the second polarization direction P2 and the second alignment direction C2 is 15°.

FIG. 13 is a schematic diagram of an optical path in a case that a viewing angle controller is in a second state according to an embodiment of the present disclosure.

Furthermore, reference is made to FIG. 13, the incident direction of the first light L1 inclines towards a first direction A1 relative to the front-viewing direction F, and the first direction A1 has a positive direction. The incident direction of the first light L1 and a positive direction of the first direction A1 form an acute angle.

In one embodiment, the front-viewing direction F is served as a reference. In a case that a certain light inclines significantly towards the positive direction of the first direction A1, the transmittance of this light in the first state is greater than the transmittance of this light in the second state. In one embodiment, the light may be the first light L1. In a case that a certain light inclines slightly towards the positive direction of the first direction A1, the transmittance of this light in the first state is not significantly different from the transmittance of this light in the second state. In one embodiment, the light may be the second light L2. In a case that a certain light inclines towards a negative direction of the first direction A1, the transmittance of this light in the first state is not significantly different from the transmittance of this light in the second state. In one embodiment, the light may be a zero light L0. It should be noted that when an observer observes the first liquid crystal controlling box 1 in the front-viewing direction F, a left side and a right side in a horizontal direction and an upper side and a lower side in a vertical direction may be determined based on the observer. In a case that the first direction A1 is defined as the horizontal direction and the left side is defined as the positive direction, the incident direction of the first light L1 inclines towards the left side relative to vertically incident light.

Furthermore, a phase retardance of the first liquid crystal layer 13 ranges from 200 nm to 1000 nm. The first liquid crystal layer 13 deflects the polarization direction of light. The deflection angle in the first state is different from the deflection angle in the second state. The phase retardance of the first liquid crystal layer 13 may be configured to represent a deflection angle difference. There is a critical light between the first light L1 and the second light L2. In a case that an inclination of a light is greater than an inclination of the critical light, it may be determined that the transmittance of this light in the second state is significantly less than the transmittance of this light in the first state, such as the first light L1. In a case that an inclination of light is less than the inclination of the critical light, it may be determined that the transmittance of this light in the second state is not significantly different from the transmittance of this light in the first state, such as the second light L2. The phase retardance of the first liquid crystal layer 13 is correlated with the inclination of the critical light relative to the front-viewing direction. The inclination of the critical light between the first light L1 and the second light L2 may be adjusted by modifying the phase retardance of the first liquid crystal layer 13.

In one embodiment, the phase retardance of the first liquid crystal layer 13 ranges from 200 nm to 1000 nm, and the transmittance of the first light L1 is less than the transmittance of the second light L2 in the second state. It should be noted that the phase retardance of the first liquid crystal layer 13 is correlated with a thickness of the first liquid crystal layer 13 and a material property of the liquid crystal molecules 131.

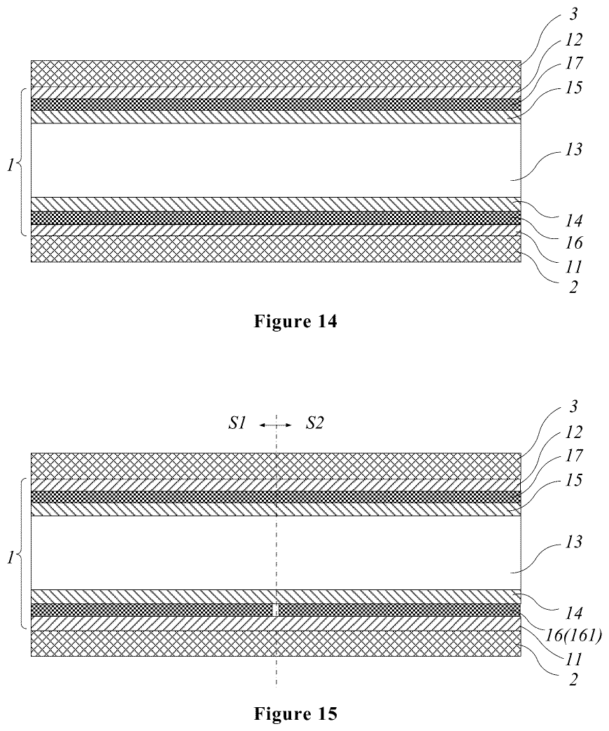

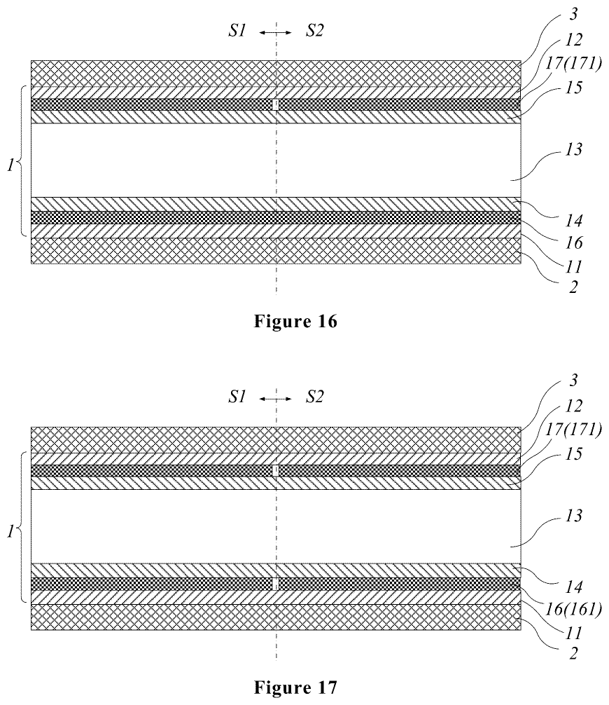

FIG. 14 is a schematic structural diagram of a viewing angle controller according to another embodiment of the present disclosure. FIG. 15 is a schematic structural diagram of a viewing angle controller according to another embodiment of the present disclosure. FIG. 16 is a schematic structural diagram of a viewing angle controller according to another embodiment of the present disclosure. FIG. 17 is a schematic structural diagram of a viewing angle controller according to another embodiment of the present disclosure.

Furthermore, reference is made to FIGS. 14 to 17, a first region S1 of the first liquid crystal controlling box 1 and a second region S2 of the first liquid crystal controlling box 1 are arranged in parallel. The first liquid crystal controlling box 1 includes a first electrode 16 and a second electrode 17. The first electrode 16 is arranged between the first liquid crystal layer 13 and the first substrate 11. The second electrode 17 is arranged between the first liquid crystal layer 13 and the second substrate 12. The first electrode 16 includes multiple first sub-electrodes 161 spaced apart from each other, and a distance between adjacent first sub-electrodes 161 is greater than or equal to 10 microns; and/or, the second electrode 17 includes multiple second sub-electrodes 171 spaced apart from each other, and a distance between adjacent second sub-electrodes 171 is greater than or equal to 10 microns.

The first region S1 and the second region S2 are arranged in parallel. The first region S1 may be identical to or different from the second region S2 in anti-pecking function. That is, a voltage difference between the first electrode 16 and the second electrode 17 in the first region S1 may be equal to or unequal to voltage difference between the first electrode 16 and the second electrode 17 in the second region S2. Among the multiple spaced first sub-electrodes 161 of the first electrode 16, at least one of the first sub-electrodes 161 is arranged in the first region S1, and at least one of the first sub-electrodes 161 is arranged in the second region S2. A minimum distance between two adjacent first sub-electrodes 161 is greater than or equal to 10 microns, which can reduce the mutual crosstalk of electric fields corresponding to two adjacent first sub-electrodes 161. Similarly, among the multiple spaced second sub-electrodes 171 of the second electrode 17, at least one of the second sub-electrodes 171 is arranged in the first region S1, and at least one of the second sub-electrodes 171 is arranged in the second region S2. A minimum distance between two adjacent second sub-electrodes 171 is greater than or equal to 10 microns, which can reduce the mutual crosstalk of electric fields corresponding to two adjacent second sub-electrodes 171.

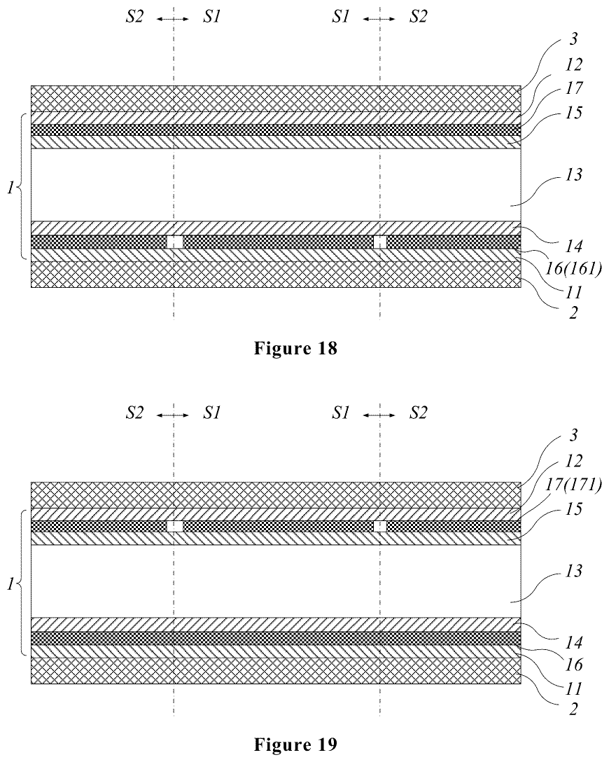

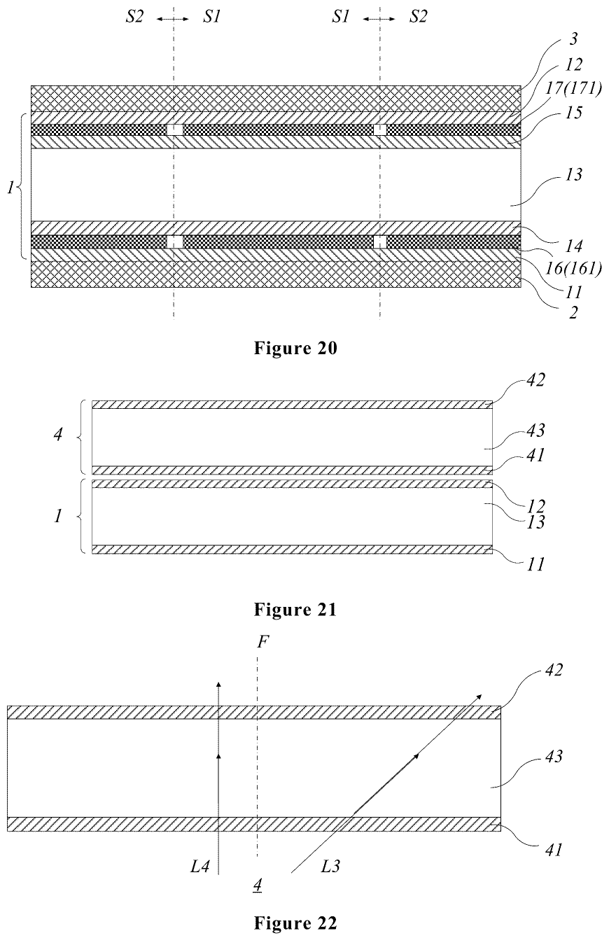

FIG. 18 is a schematic structural diagram of a viewing angle controller according to another embodiment of the present disclosure. FIG. 19 is a schematic structural diagram of a viewing angle controller according to another embodiment of the present disclosure. FIG. 20 is a schematic structural diagram of a viewing angle controller according to another embodiment of the present disclosure.

Furthermore, reference is made to FIGS. 18 to 20, the first liquid crystal controlling box 1 further includes a first electrode 16, and a second electrode 17. A distance between the first region S1 of the first liquid crystal controlling box 1 and an edge of the viewing angle controller is greater than a distance between the second region S2 of the first liquid crystal controlling box 1 and the edge of the viewing angle controller. The first electrode 16 is arranged between the first liquid crystal layer 13 and the first substrate 11. The second electrode 17 is arranged between the first liquid crystal layer 13 and the second substrate 12. At least one of configuration requirements for the first electrode 16 and configuration requirements for the second electrode 17 is required to be satisfied in the present disclosure. The configuration requirements for the first electrode 16 are as follows. The first electrode 16 includes multiple first sub-electrodes 161 spaced apart from each other. At least one of the multiple first sub-electrodes 161 is arranged in the first region S1, and at least one of the multiple first sub-electrodes 161 is arranged in the second region S2. In the second state, a voltage difference between the first sub-electrode 161 and the second electrode 17 in the first region S1 is V1, and a voltage difference between the first sub-electrode 161 and the second electrode 17 in the second region S2 is V2, where V1≥V2. The configuration requirements for the second electrode 17 are as follows. The second electrode 17 includes multiple second sub-electrodes 171 spaced apart from each other. At least one of the multiple second sub-electrodes 171 is arranged in the first region S1, and at least one of the multiple second sub-electrodes 171 is arranged in the second region S2. In the second state, a voltage difference between the second sub-electrode 171 and the first electrode 16 in the first region S1 is V1, and a voltage difference between the second sub-electrode 171 and the first electrode 16 in the second region S2 is V2, where V1≥V2.

The first region S1 is arranged in the middle of the viewing angle controller, and the second region S2 at least partially surrounds the first region S1. Among the multiple spaced first sub-electrodes 161 of the first electrode 16, at least one of the first sub-electrodes 161 is arranged in the first region S1, and at least one of the first sub-electrodes 161 is arranged in the second region S2. The first liquid crystal controlling box 1 operates in the second state, and a maximum viewable inclination angle in the range of the actual viewing angle is negatively correlated with the voltage difference between the first electrode 16 and the second electrode 17. Since the voltage difference V1 between the first sub-electrode 161 and the second electrode 17 in the first region S1 is greater than or equal to the voltage difference V2 between the first sub-electrode 161 and the second electrode 17 in the second region S2, the range of the viewing angle in the first region S1 is relatively small, while the range of the viewing angle in the second region S2 is relatively large. In a case that the display panel is large or the user is close to the display panel, the user views the first region S1 of the display panel at a viewing angle close to the front-viewing angle, and the user views the second region S2 of the display panel at a large inclined viewing angle. Therefore, the user may view the screen displayed on the display panel in both the first region S1 and the second region S2 by reducing the limitation of the viewing angle in second region S2. Similarly, among the multiple spaced second sub-electrodes 171 of the second electrode 17, at least one of the second sub-electrodes 171 is arranged in the first region S1, and at least one of the second sub-electrodes 171 is arranged in the second region S2. In the second state, the voltage difference V1 between the second sub-electrode 171 and the first electrode 16 in the first region S1 is greater than or equal to the voltage difference V2 between the second sub-electrode 171 and the first electrode 16 in the second region S2, and thus the range of the viewing angle in the first region S1 is relatively small, while the range of the viewing angle in the second region S2 is relatively large. In a case that the display panel is large or the user is close to the display panel, the user observes the first region S1 at a small inclined viewing angle, which can view the screen displayed in the first region S1. In addition, the user observes the second region S2 at a large inclined viewing angle, which can also view the screen displayed in the second region S2. The viewing angle controller herein is applied to the display device, and the display device can not only achieve directional anti-pecking at a large viewing angle, but also reduce the impact of anti-pecking function on the display effect at non-anti-peeking viewing angles.

In some embodiments, there may be at least two second regions S2, which are arranged on two opposite sides of the first region S1 respectively. The liquid crystal molecules in the two second regions S2 have opposite preset inclination angles, that is, preset inclination directions of the liquid crystal molecules in the two second regions S2 are symmetrical with respect to the first region S1.

In an embodiment, the liquid crystal molecule in the second region S2 inclines in a direction away from the first region S1 along the direction from the first substrate 11 to the second substrate 12.

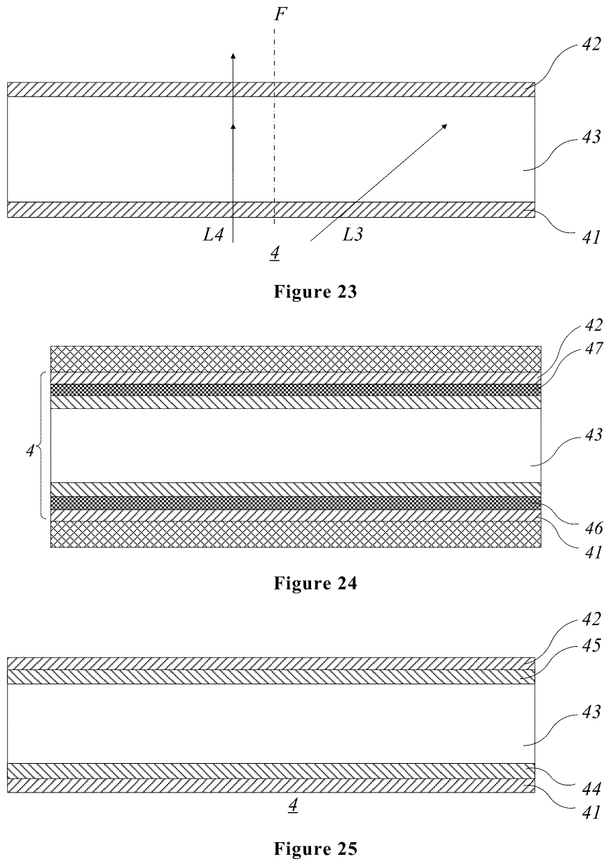

FIG. 21 is a schematic structural diagram of a viewing angle controller according to another embodiment of the present disclosure. FIG. 22 is a schematic diagram of an optical path in a second liquid crystal controlling box of a viewing angle controller in a third state according to an embodiment of the present disclosure. FIG. 23 is a schematic diagram of an optical path in a second liquid crystal controlling box of a viewing angle controller in a fourth state according to an embodiment of the present disclosure.

Furthermore, reference is made to FIGS. 21 to 23, the liquid crystal controlling box further includes a second liquid crystal controlling box 4. The second liquid crystal controlling box 4 includes a third substrate 41, a fourth substrate 42, and a second liquid crystal layer 43 arranged between the third substrate 41 and the fourth substrate 42. The second liquid crystal controlling box 4 is configured to operate in a third state or in a fourth state. The transmittance of the second liquid crystal controlling box 4 with respect to the third light L3 in the fourth state is less than one or both of the transmittance of the second liquid crystal controlling box 4 with respect to the third light L3 in the third state and the transmittance of the second liquid crystal controlling box 4 with respect to the fourth light L4 in the fourth state. An inclination of the third light L3 relative to the front-viewing direction F of the viewing angle controller is greater than the inclination of the fourth light LA relative to the front-viewing direction F of the viewing angle controller.

The number of the liquid crystal controlling box may be at least two. The liquid crystal controlling box further includes the second liquid crystal controlling box 4. The third substrate 41 and the fourth substrate 42 of the second liquid crystal controlling box 4 are configured to form a box structure of the second liquid crystal controlling box 4, and accommodate the second liquid crystal layer 43 to form the second liquid crystal controlling box 4. The light may be incident from the third substrate 41 and irradiated towards the fourth substrate 42.

The second liquid crystal controlling box 4 is configured to operate in the third state or in the fourth state. Generally, the second liquid crystal controlling box 4 applies an electric field through an electrode and changes the state by changing the electric field. In a case that the electrode is not energized, the second liquid crystal layer 43 of the second liquid crystal controlling box 4 is not in the electric field, and the second liquid crystal controlling box 4 is in the third state, which indicates that the second liquid crystal controlling box 4 does not operate. In a case that the electrode is energized, the second liquid crystal layer 43 of the second liquid crystal controlling box 4 is in the electric field, and the second liquid crystal controlling box 4 is in the fourth state, which indicates that the second liquid crystal controlling box 4 operates. The front-viewing direction F is a direction perpendicular to a plane where the first substrate 11 is located, which indicates that the front-viewing direction F is parallel to a normal line of incident light. For the convenience of description, optical characteristics of the second liquid crystal controlling box 4 in different states are explained through the third light L3 and the fourth light L4. The inclination of the third light L3 relative to the front-viewing direction F of the viewing angle controller is greater than the inclination of the fourth light LA relative to the front-viewing direction F of the viewing angle controller. Considering that the front-viewing direction F is parallel to the normal line of the incident light, the inclination of the light relative to the front-viewing direction F of the viewing angle controller indicates an incident angle of the light. A large inclination engenders a large incident angle. Therefore, the incident angle of the third light L3 is greater than the incident angle of the fourth light L4.

The transmittance of the second liquid crystal controlling box 4 with respect to the third light L3 in the third state is greater than the transmittance of the first liquid crystal controlling box 1 with respect to the third light L3 in the fourth state. In the fourth state, liquid crystal of the second liquid crystal controlling box 4 is deflected at a certain angle in a direction perpendicular to the second liquid crystal controlling box 4, and it is difficult for the inclined third light L3 to pass through the second liquid crystal controlling box 4 after the liquid crystal is deflected, and the transmittance of the inclined third light L3 is reduced. In such case, it is difficult for the inclined light to pass through the second liquid crystal controlling box 4. That is, the second liquid crystal controlling box 4 can limit the transmission of the inclined light during operation. The viewing angle controller according to the embodiment of the present disclosure is applied to the display device, and the screen displayed on the display panel is difficult to be viewed at a large viewing angle, which prevents others from pecking at the display device.

The transmittance of the second liquid crystal controlling box 4 with respect to the third light L3 in the fourth state is lower than the transmittance of the second liquid crystal controlling box 4 with respect to the fourth light L4 in the fourth state. In the fourth state, the second liquid crystal controlling box 4 during operation can limit the transmission of the light with a large inclination. The viewing angle controller herein is applied to the display device, and the screen displayed on the display panel is difficult to be viewed at a large viewing angle, which prevents others from peeking at the display device, while the screen displayed on the display panel may be viewed at a small viewing angle.

FIG. 24 is a schematic structural diagram of a second liquid crystal controlling box of a viewing angle controller according to an embodiment of the present disclosure.

Reference is made to FIG. 24, the second liquid crystal controlling box 4 further includes a third electrode 46 and a fourth electrode 47. The third electrode 46 is arranged between the second liquid crystal layer 43 and the third substrate 41. The fourth electrode 47 is arranged between the second liquid crystal layer 43 and the fourth substrate 42. In the fourth state, a voltage difference between the third electrode 46 and the fourth electrode 47 ranges from 1.5V to 4V.

In a case that the second liquid crystal controlling box 4 is in the third state, a voltage difference between the third electrode 46 and the fourth electrode 47 is 0V, and the second liquid crystal layer 43 is not in the electric field, which indicates that the second liquid crystal controlling box 4 does not operate, and the display panel is displayed normally. In a case that the second liquid crystal controlling box 4 is in the fourth state, a voltage difference between the third electrode 46 and the fourth electrode 47 ranges from 1.5V to 4V, and the second liquid crystal layer 43 is in the electric field, which indicates that the second liquid crystal controlling box 4 operates, and the display panel is in an anti-pecking state. It should be noted that in a case that the first liquid crystal controlling box 1 is in the first state, the second liquid crystal controlling box 4 may be in the third state or in the fourth state; and in a case that the first liquid crystal controlling box 1 is in the second state, the second liquid crystal controlling box 4 may be in the third state or in the fourth state.

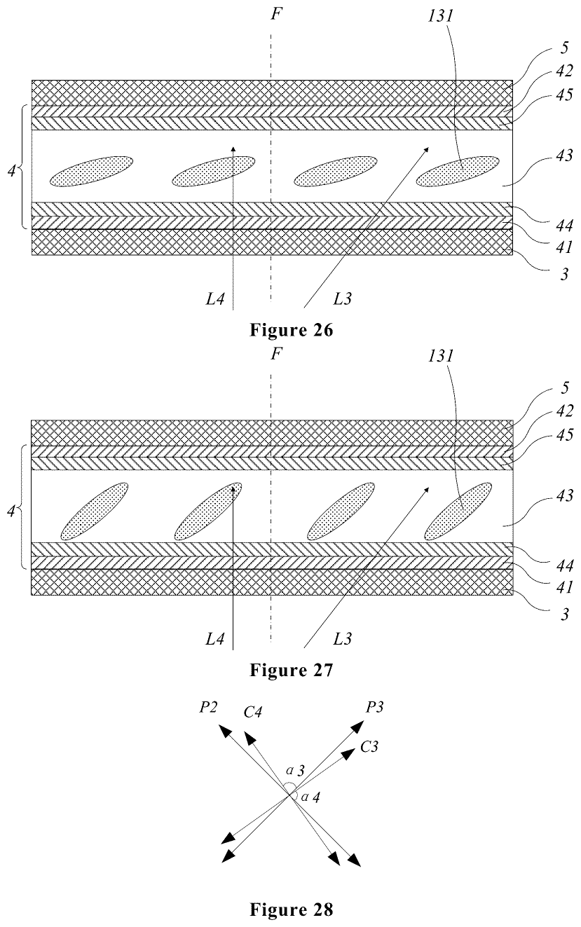

FIG. 25 is a schematic structural diagram of a second liquid crystal controlling box of a viewing angle controller according to another embodiment of the present disclosure. FIG. 26 is a schematic structural diagram of a second liquid crystal controlling box of a viewing angle controller in a third state according to an embodiment of the present disclosure. FIG. 27 is a schematic structural diagram of a second liquid crystal controlling box of a viewing angle controller in a fourth state according to an embodiment of the present disclosure. FIG. 28 is a schematic structural diagram illustrating alignment directions and polarization directions in a viewing angle controller in a direction perpendicular to a plane where a second liquid crystal layer is located according to an embodiment of the present disclosure.

Furthermore, reference is made to FIGS. 25 to 28, the second liquid crystal controlling box 4 includes a third alignment film 44 and a fourth alignment film 45. The third alignment film 44 is arranged on a side of the second liquid crystal layer 43 facing the third substrate 41, and has a third alignment direction C3. The fourth alignment film 45 is arranged on a side of the second liquid crystal layer 43 facing the fourth substrate 42, and has a fourth alignment direction C4. In the third state, the liquid crystal molecule in the second liquid crystal layer 43 is rotated clockwise or counterclockwise in the direction from the third substrate 41 to the fourth substrate 42.

In the direction from the third substrate 41 to the fourth substrate 42, at least a part of the liquid crystal molecules 131 in the second liquid crystal layer 43 may be arranged to be in multiple layers. Regardless of whether the second liquid crystal controlling box 4 is in the third state or in the fourth state, the liquid crystal molecules in the multiple layers are arranged in a direction from the third alignment film 44 to the fourth alignment film 45. The third alignment film 44 is arranged on the side of the second liquid crystal layer 43 facing the third substrate 41. On the plane where the third substrate 41 is located, the long axis direction of the liquid crystal molecule closest to the third alignment film 44 is parallel to the third alignment direction C3. The fourth alignment film 45 is arranged on the side of the second liquid crystal layer 43 facing the fourth substrate 42, and has the fourth alignment direction C4. On the plane where the third substrate 41 is located, a long axis direction of an orthographic projection of the liquid crystal molecule closest to the fourth alignment film 45 is parallel to the fourth alignment direction C4.

In one embodiment, the liquid crystal molecules 131 have positive dielectric anisotropy. In the third state, the second liquid crystal controlling box 4 is observed along the front-viewing direction F of the second liquid crystal controlling box 4, and the liquid crystal molecules in different layers are gradually rotated clockwise or counterclockwise along the direction from the third substrate 41 to the fourth substrate 42. The second liquid crystal controlling box 4 is observed along the front-viewing direction F of the second liquid crystal controlling box 4 at a same position, the liquid crystal molecules 131 in different layers form projections on the plane where the third substrate 41 is located. Projections of centers of multiple liquid crystal molecules arranged in different layers overlap at one point. The projections of the liquid crystal molecules in different layers are gradually rotated clockwise or counterclockwise around the point. On the plane where the third substrate 41 is located, the long axis direction of the orthographic projections of multiple liquid crystal molecules are gradually rotated in the direction from the third substrate 41 to the fourth substrate 42.

Furthermore, reference is made to FIGS. 25 to 28, the viewing angle controller herein further includes a second polarizer 3 and a third polarizer 5. The second polarizer 3 is arranged on a side of the third substrate 41 away from the third alignment film 44, and has a second polarization direction P2. The third polarizer 5 is arranged on a side of the fourth substrate 42 away from the fourth alignment film 45, and has a third polarization direction P3. The second polarization direction P2 is perpendicular to the third polarization direction P3. An angle α3 formed by the second polarization direction P2 and the third alignment direction C3 meets 0°≤α3≤180°, and 0°≤|α1−k×90°|≤15°, where k may be 0, 1, or 2. An angle α4 formed by the third polarization direction P3 and the fourth alignment direction C4 meets: 0°≤α4≤180°, and 0°≤|α4−k×90°|≤15°, where k may be 0, 1, or 2.

The light is transmitted into the second liquid crystal controlling box 4 through the second polarizer 3, and forms polarized light along the second polarization direction P2. The polarized light is deflected by the second liquid crystal controlling box 4, to rotate the polarization direction. When the polarization direction is rotated to be parallel to the third polarization direction P3, the light may be emitted from the third polarizer.

For the convenience of description, the liquid crystal molecules 131 have positive dielectric anisotropy herein. Reference is made to FIG. 26, in the third state, the long axis direction of the liquid crystal molecules 131 is almost parallel to the plane where the third substrate 41 is located. When the third light L3 and the fourth light LA pass through the second polarizer 3, both a polarization direction of the third light L3 and a polarization direction of the fourth light L4 are parallel to the third polarization direction P3. When the third light L3 and the fourth light L4 are incident on the liquid crystal molecules 131, both the polarization direction of the third light L3 and the polarization direction of the fourth light LA are deflected, and both a deflected polarization direction of the third light L3 and a deflected polarization direction of the fourth light L4 are parallel to the third polarization direction P3, and both the third light L3 and the fourth light L4 can be emitted from the third polarizer 5. Reference is made to FIG. 27, in the fourth state, the liquid crystal molecules 131 are rotated at an angle. When the third light L3 is incident on the liquid crystal molecules 131, an incident direction of the third light L3 is almost parallel to the long axis direction of the liquid crystal molecules 131, and a small acute angle is formed. After the third light L3 is incident on the liquid crystal molecules 131, the polarization direction of the third light L3 is deflected, and the deflected polarization direction intersects with the third polarization direction P3, and a relatively large acute angle is formed, and the third light L3 is difficult to pass through the third polarizer 5. Therefore, the transmittance of the third light L3 in the fourth state is reduced. When the fourth light LA is incident on the liquid crystal molecules 131, an incident direction of the fourth light L4 intersects with the long axis direction of the liquid crystal molecules 131 to form a relatively large acute angle. After the fourth light LA is incident on the liquid crystal molecules 131, the polarization direction of the fourth light L4 is deflected, and the deflected polarization direction intersects with the third polarization direction P3 to form a small acute angle, and the fourth light L4 is easy to pass through the third polarizer 5. Therefore, the transmittance of the fourth light L4 in the fourth state is almost unchanged.

The third alignment direction C3 and the fourth alignment direction C4 of the second liquid crystal controlling box 4 determine a rotation angle of the polarization direction of the light. In one embodiment, the angle α3 formed by the second polarization direction P2 and the third alignment direction C3 meets 0°≤α3≤180°, and 0°≤|α3−k×90°|≤15°, where k may be 0, 1, or 2. The angle α4 formed by the third polarization direction P3 and the fourth alignment direction C4 meets: 0°≤α4≤180°, and 0°≤|α4−k×90°|≤15°, where k may be 0, 1, or 2. That is, the second polarization direction P2 of the second polarizer 3 is perpendicular to or parallel to the third alignment direction C3, and an upper limit of a position error between the second polarization direction P2 and the third alignment direction C3 is 15°. Similarly, the third polarization direction P3 of the third polarizer 5 is perpendicular to or parallel to the fourth alignment direction C4, and an upper limit of a position error between the third polarization direction P3 and the fourth alignment direction C4 is 15°.

It should be noted that the light after passing through the first liquid crystal controlling box 1 may pass through the second polarizer 3 and enter the second liquid crystal controlling box 4. That is, a polarizer arranged on a light emitting side of the first liquid crystal controlling box 1 is also a polarizer arranged on a light incident side of the second liquid crystal controlling box.

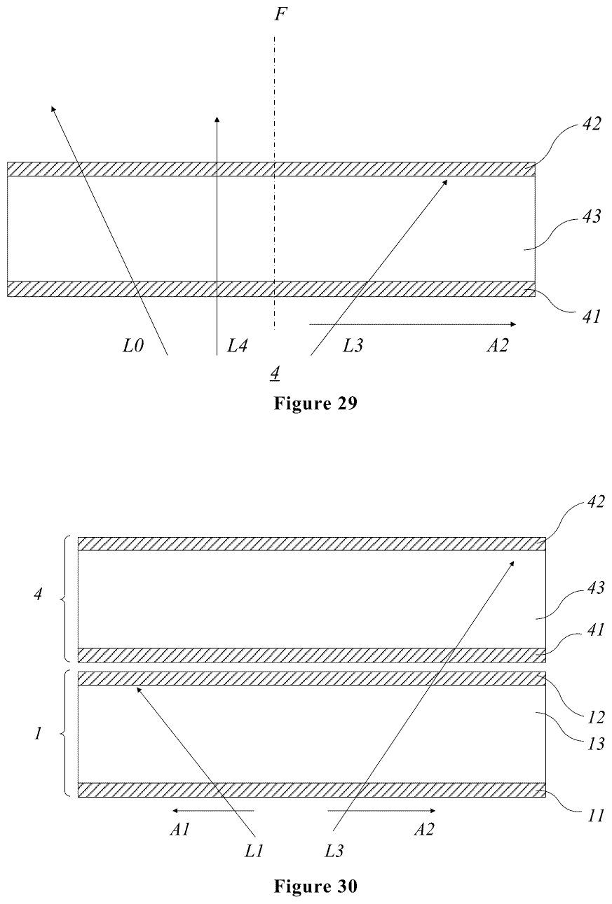

FIG. 29 is a schematic diagram of an optical path in a second liquid crystal controlling box of a viewing angle controller in a fourth state according to another embodiment of the present disclosure.

Furthermore, reference is made to FIG. 29, an incident direction of the third light L3 inclines towards a second direction A2 relative to the front-viewing direction F, and the second direction A2 has a positive direction. The incident direction of the third light L3 and the positive direction of the second direction A2 form an acute angle.

In one embodiment, the front-viewing direction F is served as a reference. In a case that a certain light inclines significantly towards the positive direction of the second direction A2, the transmittance of this light in the third state is greater than the transmittance of this light in the fourth state. In one embodiment, the light may be the third light L3. In a case that a certain light inclines slightly towards the positive direction of the second direction A2, the transmittance of this light in the third state is not significantly different from the transmittance of this light in the fourth state. In one embodiment, the light may be the fourth light L4. In a case that a certain light inclines towards a negative direction of the second direction A2, the transmittance of this light in the third state is not significantly different from the transmittance of this light in the fourth state. In one embodiment, the light may be a zero light L0. It should be noted that when an observer observes the second liquid crystal controlling box 4 in the front-viewing direction F, a left side and a right side in a horizontal direction and an upper side and a lower side in a vertical direction may be determined based on the observer. In a case that the second direction A2 is defined as the horizontal direction and the right side is defined as the positive direction, the incident direction of the first light L1 inclines towards the right side relative to vertically incident light.

The positive direction of the first direction A1 may be different from the positive direction of the second direction A2. The first liquid crystal controlling box 1 and the second liquid crystal controlling box 4 are configured for preventing others from peeking at the display device at a large viewing angle in different inclination directions. For example, in a case that the positive direction of the first direction A1 is opposite to the positive direction of the second direction A2, the first liquid crystal controlling box 1 and the second liquid crystal controlling box 4 may prevent others from pecking at the display device at a large viewing angle at both sides of the direction. In such case, in a case that the liquid crystal molecule of the first liquid crystal controlling box 1 and the liquid crystal molecule of the second liquid crystal controlling box 4 both have positive dielectric anisotropy, an inclination direction of the liquid crystal molecules of the first liquid crystal controlling box 1 is opposite to an inclination direction of the liquid crystal molecules of the second liquid crystal controlling box 4, and both of the inclination directions are symmetrical with respect to the front-viewing angle.

In one embodiment, the positive direction of the first direction A1 may be identical to the positive direction of the second direction A2. The first liquid crystal controlling box 1 and the second liquid crystal controlling box 4 have a stacked anti-pecking effect at a large viewing angle on the same direction. In such case, in a case that the liquid crystal molecule of the first liquid crystal controlling box 1 and the liquid crystal molecule of the second liquid crystal controlling box 4 both have positive dielectric anisotropy, the inclination direction of the liquid crystal molecule of the first liquid crystal controlling box 1 is identical to the inclination direction of the liquid crystal molecule of the second liquid crystal controlling box 4.

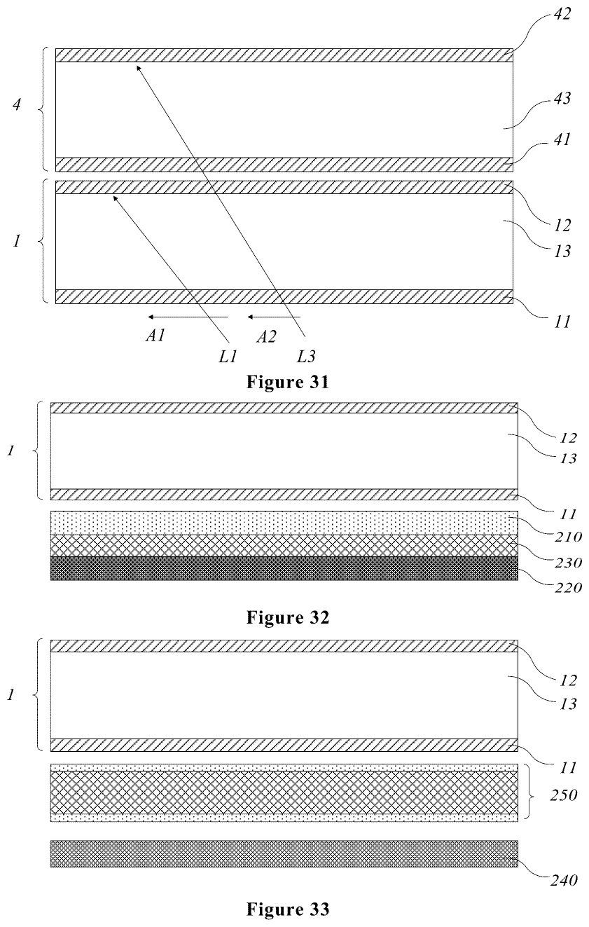

FIG. 30 is a schematic diagram of an optical path in a viewing angle controller where a first liquid crystal controlling box is in a second state and a second liquid crystal controlling box is in a fourth state according to an embodiment of the present disclosure. FIG. 31 is a schematic diagram of an optical path in a viewing angle controller a first liquid crystal controlling box is in a second state and a second liquid crystal controlling box is in a fourth state according to another embodiment of the present disclosure.

Furthermore, reference is made to FIGS. 30 and 31, the incident direction of the first light L1 inclines towards the first direction A1 relative to the front-viewing direction F, and the first direction A1 has a positive direction. The incident direction of the first light L1 and the positive direction of the first direction A1 form an acute angle. The first direction A1 is parallel to the second direction A2.

The first direction A1 of the first liquid crystal controlling box 1 is parallel to the second direction A2 of the second liquid crystal controlling box 4. In a case that the positive direction of the first direction A1 is identical to the positive direction of the second direction A2, the first liquid crystal controlling box 1 and the second liquid crystal controlling box 4 can enhance the viewing angle limitation effect on the positive direction of the first direction A1. In a case that the positive direction of the first direction A1 is opposite to the positive direction of the second direction A2, the first liquid crystal controlling box 1 and the second liquid crystal controlling box 4 may limit the viewing angle in the positive direction and the negative direction of the first direction A1 respectively. In one embodiment, in a case that the first direction A1 is parallel to the horizontal direction, the first liquid crystal controlling box 1 and the second liquid crystal controlling box 4 may control the viewing angle on the left side and the right side respectively.

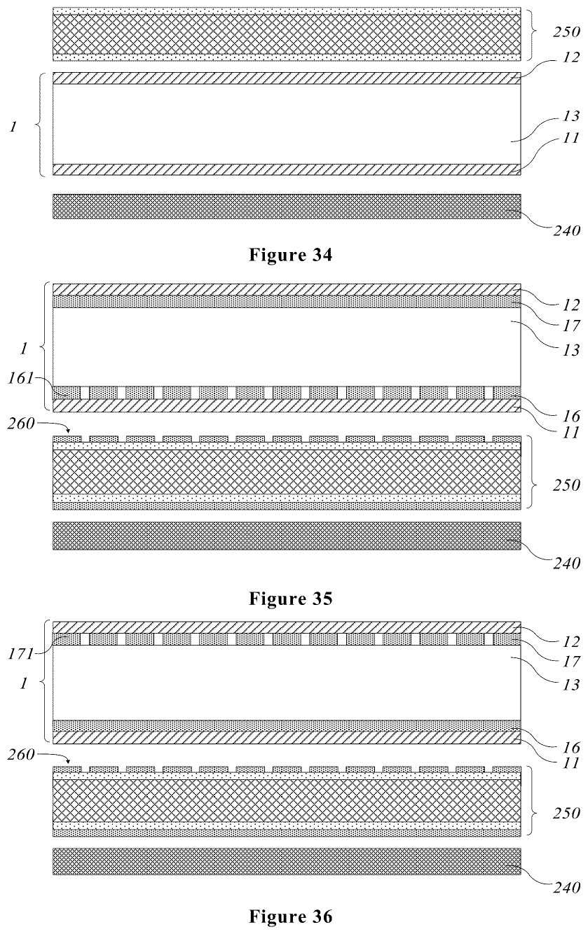

FIG. 32 is a schematic structural diagram of a display panel according to an embodiment of the present disclosure. FIG. 33 is a schematic structural diagram of a display panel according to another embodiment of the present disclosure. FIG. 34 is a schematic structural diagram of a display panel according to another embodiment of the present disclosure.

Reference is made to FIGS. 32 to 34, a display panel is further provided according to an embodiment of the present disclosure. The display panel includes a viewing angle controller. The viewing angle controller is provided according to any one of the foregoing embodiments of the present disclosure, and the anti-pecking function of the display panel can be achieved through the viewing angle controller.

Furthermore, reference is made to FIG. 32, the display panel according to the embodiment of the present disclosure further includes a light-emitting device layer 210 with an emitting-light side. The viewing angle controller is arranged on the light-emitting side of the light emitting device layer 210.

The light-emitting device layer 210 is configured to emit light. For example, the light-emitting device layer 210 may be an organic light-emitting diode (OLED), a micro light-emitting diode (Micro-LED), or a small light-emitting diode (Mini-LED). The viewing angle controller is arranged on the light-emitting side of the light-emitting device layer 210, and the first substrate 11 of the viewing angle controller is arranged facing the light-emitting device layer 210, and the light emitted by the light-emitting device needs to pass through the viewing angle controller before being viewed by the user.

The display panel further includes a substrate 220 and an array layer 230. The substrate 220 may be made of a polymer material such as glass, polyimide (PI), polycarbonate (PC), polyethersulfone (PES), polyethylene terephthalate (PET), polyethylene naphthalate (PEN), polyarylate (PAR), or glass fiber reinforced plastic (FRP). The substrate 220 may be transparent, translucent, or opaque. The array layer 230 includes multiple thin film transistors (TFT) and a pixel circuit formed by the thin film transistors, and is configured to control the light-emitting device layer 210 to emit light.

Furthermore, reference is made to FIGS. 33 and 34, the display panel herein further includes a backlight layer 240 with a light-emitting side and a liquid crystal display box 250. The viewing angle controller is arranged on the light-emitting side of the backlight layer 240. The liquid crystal display box 250 is arranged between the backlight layer 240 and the viewing angle controller, or arranged on a side of the viewing angle controller away from the backlight layer 240.

Herein the display panel adopts a liquid crystal display (LCD) panel. The backlight layer 240 is configured to provide backlight for the display panel. The viewing angle controller is arranged on the light-emitting side of the backlight layer 240, and the first substrate 11 of the viewing angle controller is arranged facing the backlight layer 240, and the light emitted by the backlight layer 240 needs to pass through the viewing angle controller before being viewed by the user. The liquid crystal display box 250 is configured to adjust brightness of backlight for different pixel units. A position where the liquid crystal display box 250 is located is not limited. The liquid crystal display box 250 may be arranged between the backlight layer 240 and the viewing angle controller, or arranged on the side of the viewing angle controller away from the backlight layer 240.

Furthermore, reference is made to FIGS. 33 and 34, a thickness of the liquid crystal display box 250 is less than a thickness of the at least one liquid crystal controlling box.

The liquid crystal display box 250 is not too thick, in order to ensure that incident light can be smoothly transmitted and ensure a polarization direction of the deflected light. In addition to the polarization direction of the deflected light, the liquid crystal controlling box prevents part of the light from being emitted, and thus the thickness of the liquid crystal controlling box is greater than the thickness of the liquid crystal display box 250.

FIG. 35 is a schematic structural diagram of a display panel according to another embodiment of the present disclosure. FIG. 36 is a schematic structural diagram of a display panel according to another embodiment of the present disclosure.

Furthermore, reference is made to FIGS. 35 and 36, the display panel herein further includes multiple pixel units 260 arranged in an array. The first liquid crystal controlling box 1 further includes a first electrode 16 and a second electrode 17. The first electrode 16 is arranged between the first liquid crystal layer 13 and the first substrate 11. The number of the first electrode 16 is more than one, and the multiple first electrodes 16 and the multiple pixel units 260 are in one-to-one correspondence; and/or, the number of the second electrode 17 is more than one, and the multiple second electrodes and the multiple pixel units 260 are in one-to-one correspondence.

The number of the first electrodes 16 in the first liquid crystal controlling box 1 is more than one, and the first electrodes 16 and the multiple pixel units 260 are in one-to-one correspondence. A viewing angle in a region corresponding to a pixel may be controlled separately by modifying a voltage difference between a single first electrode 16 and the second electrode 17. Similarly, the number of the second electrode 17 in the first liquid crystal controlling box 1 is more than one, and the second electrode 17 and the multiple pixel units 260 are in one-to-one correspondence. A viewing angle in a region corresponding to a pixel may be controlled separately by modifying a voltage difference between a single second electrode 17 and the first electrode 16.

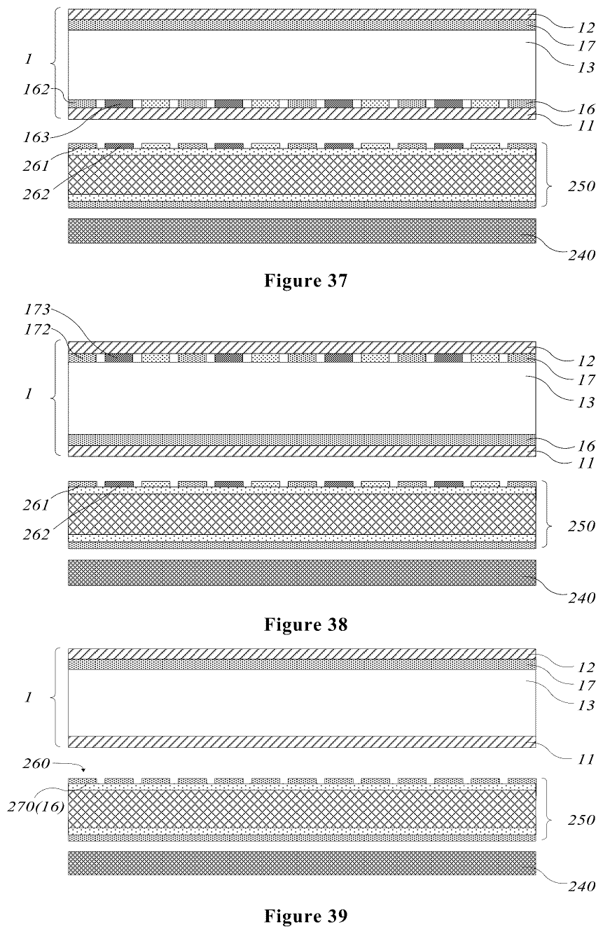

FIG. 37 is a schematic structural diagram of a display panel according to another embodiment of the present disclosure. FIG. 38 is a schematic structural diagram of a display panel according to another embodiment of the present disclosure.

Furthermore, as shown in FIGS. 37 and 38, the pixel units 260 includes a first pixel unit 261 and a second pixel unit 262. A wavelength λ1 of the light corresponding to the first pixel unit 261 and a wavelength λ2 of the light corresponding to the second pixel unit 262 meets that λ1>λ2. At least one of configuration requirements for the first electrode 16 and configuration requirements for the second electrode 17 is required to be satisfied in the present disclosure. The configuration requirements for the first electrode 16 are as follows. The first electrode 16 includes a third sub-electrode 162 and a fourth sub-electrode 163. On the surface of the first liquid crystal controlling box 1, an orthographic projection of the third sub-electrode 162 overlaps with an orthographic projection of the first pixel unit 261, and an orthographic projection of the fourth sub-electrode 163 overlaps with an orthographic projection of the second pixel unit 262. In the second state, a voltage difference V3 between the third sub-electrode 162 and the second electrode 17 and a voltage difference V4 between the fourth sub-electrode 163 and the second electrode 17 meets that V3≥V4. The configuration requirements for the second electrode 17 are as follows. The second electrode 17 includes a fifth sub-electrode 172 and a sixth sub-electrode 173. On the surface of the first liquid crystal controlling box 1, an orthographic projection of the fifth sub-electrode 172 overlaps with an orthographic projection of the first pixel unit 261, and an orthographic projection of the sixth sub-electrode 173 overlaps with an orthographic projection of the second pixel unit 262. In the second state, a voltage difference V3 between the fifth sub-electrode 172 and the first electrode 16 and a voltage difference V4 between the sixth sub-electrode 173 and the first electrode 16 meets that V3≥V4.

The pixel units 260 include the first pixel unit 261 and the second pixel unit 262. The wavelength λ1 of the light corresponding to the first pixel unit 261 is greater than the wavelength λ2 of the light corresponding to the second pixel unit 262. In one embodiment, the first pixel unit 261 corresponds to red light, and the second pixel unit 262 corresponds to blue light. The first electrode 16 includes the third sub-electrode 162 and the fourth sub-electrode 163. The third sub-electrode 162 corresponds to a red pixel unit, and the fourth sub-electrode 163 corresponds to a blue pixel unit. In the second state, the voltage difference V3 between the third sub-electrode 162 and the second electrode 17 is greater than or equal to the voltage difference V4 between the fourth sub-electrode 163 and the second electrode 17. The voltage difference between the third sub-electrode 162 and the second electrode 17 is increased to enhance the viewing angle limitation effect on a region corresponding to the third sub-electrode 162, to enhance the viewing angle limitation effect on the first pixel unit 261. Considering that the human eye is more sensitive to the red light, the human eye can feel the same viewing angle limitation effect at different pixel units. Similarly, the second electrode 17 includes the fifth sub-electrode 172 and the sixth sub-electrode 173. The fifth sub-electrode 172 corresponds to the red pixel unit, and the sixth sub-electrode 173 corresponds to the blue pixel unit. In the second state, the voltage difference V3 between the fifth sub-electrode 172 and the first electrode 16 is greater than or equal to the voltage difference V4 between the sixth sub-electrode 173 and the first electrode 16. The voltage difference between the fifth sub-electrode 172 and the first electrode 16 is increased to enhance the viewing angle limitation effect on a region corresponding to the fifth sub-electrode 172, to enhance the viewing angle limitation effect on the first pixel unit 261. Considering that the human eye is more sensitive to the red light, the human eye can feel the same viewing angle limitation effect at different pixel units.

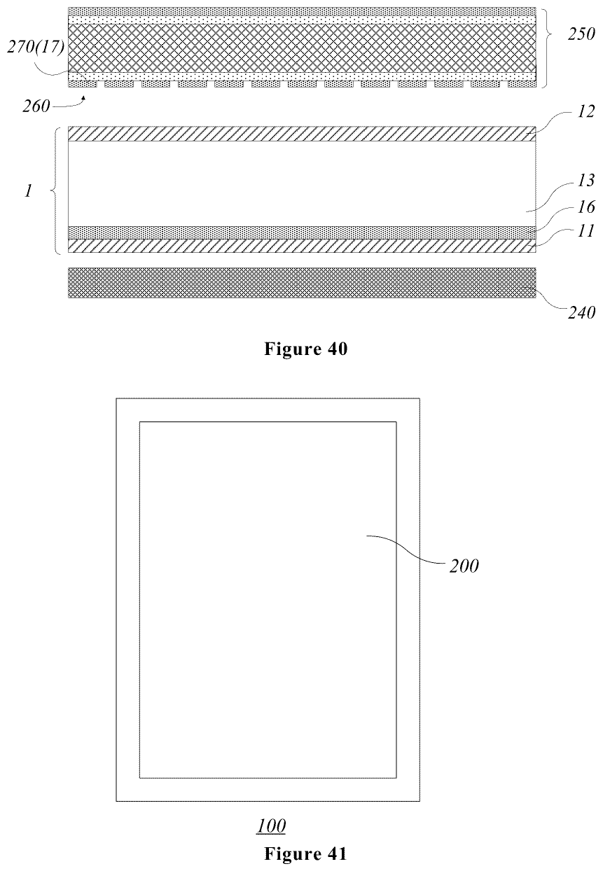

FIG. 39 is a schematic structural diagram of a display panel according to another embodiment of the present disclosure. FIG. 40 is a schematic structural diagram of a display panel according to another embodiment of the present disclosure.

Furthermore, reference is made to FIGS. 39 and 40, the display panel herein further includes a pixel electrode layer. The pixel electrode layer includes multiple pixel electrodes 270. The multiple pixel electrodes 270 and the multiple pixel units 260 are in one-to-one correspondence. The viewing angle controller further includes a first electrode 16 and a second electrode 17. The first electrode 16 is arranged on a side of the first liquid crystal layer 13 facing the first substrate 11. The second electrode 17 is arranged on a side of the first liquid crystal layer 13 facing the second substrate 12. The pixel electrode layer is arranged on a side of the first substrate 11 away from the second substrate 12, and the pixel electrodes 270 are multiplexed as the first electrode 16. In one embodiment, the pixel electrode layer is arranged on a side of the second substrate 12 away from the first substrate 11, and the pixel electrodes 270 are multiplexed as the second electrode 17.

Herein the display panel adopts a liquid crystal display panel. Each of the pixel electrodes 270 is configured to adjust brightness of backlight of a pixel unit corresponding to the pixel electrode. The pixel electrode layer is arranged on the side of the first substrate 11 away from the second substrate 12, that is, arranged on the side of the first liquid crystal layer 13 facing the first substrate 11. The pixel electrodes 270 are multiplexed as the first electrode 16, which may reduce a thickness of the display panel according to the embodiment of the present disclosure. Similarly, the pixel electrode layer is arranged on the side of the second substrate 12 away from the first substrate 11, that is, arranged on the side of the first liquid crystal layer 13 facing the second substrate 12. The pixel electrodes are multiplexed as the second electrode 17, which can reduce the thickness of the display panel according to the embodiment of the present disclosure.

FIG. 41 is a schematic structural diagram of a display device according to an embodiment of the present disclosure.

Reference is made to FIG. 41, a display device 100 is further provided according to an embodiment of the present disclosure. The display device 100 includes the display panel 200 according to any one of the foregoing embodiments of the present disclosure. The display device 100 according to the embodiment of the present disclosure may be a product or a component with a display function, such as a mobile phone, a tablet, a television, a display, a laptop, a digital picture frame, or a navigator.

In summary, the viewing angle controller, the display panel, and the display device are provided according to embodiments of the present disclosure. In the viewing angle controller, the liquid crystal controlling box is configured to control a range of a viewing angle. For the first light and the second light, the inclination of the first light relative to the front-viewing direction is greater than the inclination of the second light relative to the front-viewing direction. The transmittance of the first liquid crystal controlling box with respect to the first light in the first state is greater than the transmittance of the first liquid crystal controlling box with respect to the first light in the second state. The first liquid crystal controlling box reduces the transmittance of the first light in the second state, and it is difficult for light to pass through the liquid crystal controlling box at a large angle, to reduce the range of the viewing angle. In a case that the first liquid crystal controlling box is in the second state, the transmittance of the first light is less than the transmittance of the second light, and it is difficult for the first light with a large inclination to pass through the liquid crystal controlling box at a large angle, while the second light with a small inclination can be transmitted through the first liquid crystal controlling box at a small angle, to control the viewing angle in one direction while having no significant impact on viewing angles in other directions.

The above embodiments are only some specific embodiments of the present disclosure, and a protection scope of the present disclosure is not limited thereto. Any changes or replacements that may be easily conceived within the embodiments disclosed in the present disclosure should fall within the protection scope of the present disclosure. Therefore, the protection scope of the present disclosure should be subject to the protection scope of the claims.

What is claimed is:

1. A viewing angle controller, comprising at least one liquid crystal controlling box, wherein the at least one liquid crystal controlling box comprises a first liquid crystal controlling box, the first liquid crystal controlling box comprises:
a first substrate;
a second substrate, arranged opposite to the first substrate; and
a first liquid crystal layer, arranged between the first substrate and the second substrate, wherein:
the first liquid crystal controlling box is configured to operate in a first state or in a second state; and
a transmittance of the first liquid crystal controlling box with respect to a first light in the second state is less than one or both of: a transmittance of the first liquid crystal controlling box with respect to the first light in the first state, and a transmittance of the first liquid crystal controlling box with respect to a second light in the second state;
wherein an incident angle of the first light at a surface of the first liquid crystal controlling box is greater than an incident angle of the second light at the surface of the first liquid crystal controlling box,
or an inclination of the first light relative to a front-viewing direction of the viewing angle controller is greater than an inclination of the second light relative to the front-viewing direction of the viewing angle controller.

2. The viewing angle controller according to claim 1, wherein orientation deviation of long axes of liquid crystal molecules in the first liquid crystal layer with respect to a direction parallel to a plane where the viewing angle controller is located in the first state is less than orientation deviation of long axes of liquid crystal molecules in the first liquid crystal layer with respect to the direction parallel to the plane where the viewing angle controller is located in the second state.

3. The viewing angle controller according to claim 1, wherein the first liquid crystal layer comprises liquid crystal molecules, wherein:
the liquid crystal molecules are positive liquid crystal molecules, a first long axis of the liquid crystal molecules corresponds to a first reference line, a plane where the first liquid crystal layer is located corresponds to a first reference plane, and a first angle between the first reference line and the first reference plane ranges from 0° to 10° in the first state; or
the liquid crystal molecules are negative liquid crystal molecules, a second long axis of the liquid crystal molecules corresponds to a second reference line, the plane where the first liquid crystal layer is located corresponds to the first reference plane, and a second angle between the second reference line and the first reference plane ranges from 85° to 90° in the first state.

4. The viewing angle controller according to claim 1, wherein the first liquid crystal controlling box comprises:
a first alignment film, wherein the first alignment film is arranged on a side of the first liquid crystal layer facing the first substrate and has a first alignment direction; and
a second alignment film, wherein the second alignment film is arranged on a side of the first liquid crystal layer facing the second substrate and has a second alignment direction,
wherein in the first state, orientation of liquid crystal molecules in the first liquid crystal layer rotates clockwise or counterclockwise in a direction pointing from the first substrate to the second substrate.

5. The viewing angle controller according to claim 4, further comprising:
a first polarizer, wherein the first polarizer is arranged on a side of the first substrate away from the first alignment film and has a first polarization direction; and
a second polarizer, wherein the second polarizer is arranged on a side of the second substrate away from the second alignment film and has a second polarization direction; wherein:
the first polarization direction is perpendicular to the second polarization direction;
an angle α1 between the first polarization direction and the first alignment direction meets: 0°≤α1≤180°, and 0°≤|α1−k×90°|≤15°, wherein k is 0, 1, or 2; and
an angle α2 between the second polarization direction and the second alignment direction meets: 0°≤α2≤180°, and 0°≤|α2−k×90°≤15°, wherein k is 0, 1, or 2.

6. The viewing angle controller according to claim 1, wherein an incident direction of the first light inclines towards a first direction relative to the front-viewing direction, the first direction has a positive direction, and the incident direction of the first light and the positive direction of the first direction form an acute angle.

7. The viewing angle controller according to claim 1, wherein a phase retardance of the first liquid crystal layer ranges from 200 nm to 1000 nm.

8. The viewing angle controller according to claim 1, wherein the first liquid crystal controlling box further comprises:
a first electrode, arranged between the first liquid crystal layer and the first substrate; and
a second electrode, arranged between the first liquid crystal layer and the second substrate,
wherein a voltage difference between the first electrode and the second electrode in the second state ranges from 1.5V to 4V during operation of the viewing angle controller.

9. The viewing angle controller according to claim 1, wherein the first liquid crystal controlling box further comprises:
a first electrode, arranged between the first liquid crystal layer and the first substrate; and
a second electrode, arranged between the first liquid crystal layer and the second substrate,
wherein at least one of:
the first electrode comprises a plurality of first sub-electrodes spaced apart from each other, and a distance between adjacent first sub-electrodes among the plurality of first sub-electrodes is greater than or equal to 10 microns; or the second electrode comprises a plurality of second sub-electrodes spaced apart from each other, and a distance between adjacent second sub-electrodes among the plurality of second sub-electrodes is greater than or equal to 10 microns.

10. The viewing angle controller according to claim 1, wherein a distance from a first region of the first liquid crystal controlling box to an edge of the viewing angle controller is greater than a distance from a second region of the first liquid crystal controlling box to the edge of the viewing angle controller; and the first liquid crystal controlling box further comprises:
a first electrode, arranged between the first liquid crystal layer and the first substrate; and
a second electrode, arranged between the first liquid crystal layer and the second substrate,
wherein:
the first electrode comprises a plurality of first sub-electrodes spaced apart from each other, at least one first sub-electrode of the plurality of first sub-electrodes is arranged in the first region, and at least another first sub-electrode of the plurality of first sub-electrodes is arranged in the second region; in the second state, a voltage difference V1 between the at least one first sub-electrode in the first region and the second electrode is greater than or equal to a voltage difference V2 between the at least another first sub-electrode in the second region and the second electrode; or
the second electrode comprises a plurality of second sub-electrodes spaced apart from each other, at least one second sub-electrode of the plurality of second sub-electrodes is arranged in the first region, and at least another second sub-electrode of the plurality of second sub-electrodes is arranged in the second region; in the second state, a voltage difference V1 between the at least one second sub-electrode in the first region and the first electrode is greater than or equal to a voltage difference V2 between the at least another second sub-electrode in the second region and the first electrode.

11. The viewing angle controller according to claim 1, wherein the at least one liquid crystal controlling box further comprises a second liquid crystal controlling box, the second liquid crystal controlling box comprises:
a third substrate,
a fourth substrate, and
a second liquid crystal layer, arranged between the third substrate and the fourth substrate, wherein:
the second liquid crystal controlling box is configured to operate in a third state or in a fourth state; and
a transmittance of the second liquid crystal controlling box with respect to a third light in the fourth state is less than one or both of: a transmittance of the second liquid crystal controlling box with respect to the third light in the third state, and a transmittance of the second liquid crystal controlling box with respect to a fourth light in the fourth state;
wherein an incident angle of the third light at a surface of the second liquid crystal controlling box is greater than an incident angle of the fourth light at the surface of the second liquid crystal controlling box;
or an inclination of the third light relative to the front-viewing direction of the viewing angle controller is greater than an inclination of the fourth light relative to the front-viewing direction of the viewing angle controller.

12. The viewing angle controller according to claim 11, wherein the second liquid crystal controlling box comprises:
a third alignment film, wherein the third alignment film is arranged on a side of the second liquid crystal layer facing the third substrate and has a third alignment direction; and
a fourth alignment film, wherein the fourth alignment film is arranged on a side of the second liquid crystal layer facing the fourth substrate and has a fourth alignment direction, wherein
wherein in the third state, orientation of liquid crystal molecules in the second liquid crystal layer is rotated clockwise or counterclockwise in a direction pointing from the third substrate to the fourth substrate.

13. The viewing angle controller according to claim 12, further comprising:
a second polarizer, wherein the second polarizer is arranged on a side of the third substrate away from the third alignment film and has a second polarization direction;
a third polarizer, wherein the third polarizer is arranged on a side of the fourth substrate away from the fourth alignment film and has a third polarization direction, wherein:
the second polarization direction is perpendicular to the third polarization direction,
an angle α3 between the second polarization direction and the third alignment direction meets: 0°≤α3≤180°, and 0°≤|α3−k×90°≤15°, wherein k is 0, 1, or 2; and
an angle α4 between the third polarization direction and the fourth alignment direction meets: 0°≤α4≤180°, and 0°≤|α4−k×90°|≤15°, wherein k is 0, 1, or 2.

14. The viewing angle controller according to claim 11, wherein an incident direction of the third light inclines towards a second direction relative to the front-viewing direction, the second direction has a positive direction, and the incident direction of the third light and the positive direction of the second direction form an acute angle.

15. The viewing angle controller according to claim 14, wherein an incident direction of the first light inclines towards a first direction relative to the front-viewing direction, the first direction has a positive direction, and the incident direction of the first light and the positive direction of the first direction form an acute angle, wherein
the first direction is parallel to the second direction.

16. A display panel, comprising a viewing angle controller, wherein the viewing angle controller comprises at least one liquid crystal controlling box, and the at least one liquid crystal controlling box comprises a first liquid crystal controlling box, the first liquid crystal controlling box comprises:
a first substrate;
a second substrate, arranged opposite to the first substrate; and
a first liquid crystal layer, arranged between the first substrate and the second substrate, wherein:
the first liquid crystal controlling box is configured to operate in a first state or in a second state;
a transmittance of the first liquid crystal controlling box with respect to a first light in the second state is less than one or both of:
a transmittance of the first liquid crystal controlling box with respect to the first light in the first state, and a transmittance of the first liquid crystal controlling box with respect to a second light in the second state;
wherein an incident angle of the first light at a surface of the first liquid crystal controlling box is greater than an incident angle of the second light at a surface of the first liquid crystal controlling box,
or an inclination of the first light relative to a front-viewing direction of the viewing angle controller is greater than an inclination of the second light relative to the front-viewing direction of the viewing angle controller.

17. The display panel according to claim 16, further comprising: a light-emitting device layer, wherein the viewing angle controller is arranged on a light-emitting side of the light-emitting device layer.

18. The display panel according to claim 16, further comprising:
a backlight layer, wherein the viewing angle controller is arranged on a light-emitting side of the backlight layer; and
a liquid crystal display box, arranged between the backlight layer and the viewing angle controller, or arranged on a side of the viewing angle controller away from the backlight layer.

19. The display panel according to claim 18, wherein a thickness of the liquid crystal display box is less than a thickness of the at least one liquid crystal controlling box.

20. The display panel according to claim 16, further comprising:
a plurality of pixel units arranged in an array, wherein the first liquid crystal controlling box further comprises one or more first electrodes and one or more second electrodes, the one or more first electrode are arranged between the first liquid crystal layer and the first substrate; the one or more second electrodes are arranged between the first liquid crystal layer and the second substrate;
wherein at least one of:
a quantity of the one or more first electrodes is more than one, and the first electrodes and the pixel units in the plurality of pixel units are in one-to-one correspondence; or
a quantity of the one or more second electrodes is more than one, and the second electrodes and the pixel units in the plurality of pixel units are in one-to-one correspondence.

21. The display panel according to claim 20, wherein:
the plurality of pixel units comprises a first pixel unit and a second pixel unit, a wavelength λ1 of a light emitted by the first pixel unit is greater than a wavelength λ2 of a light emitted by the second pixel unit,
wherein at least one of:
the first electrodes comprise a third sub-electrode and a fourth sub-electrode, on the first liquid crystal controlling box, an orthographic projection of the third sub-electrode overlaps with an orthographic projection of the first pixel unit, and an orthographic projection of the fourth sub-electrode overlaps with an orthographic projection of the second pixel unit; in the second state, a voltage difference V3 between the third sub-electrode and the second electrode is greater than or equal to a voltage difference V4 between the fourth sub-electrode and the second electrode; or
the second electrodes comprise a fifth sub-electrode and a sixth sub-electrode, on the first liquid crystal controlling box, an orthographic projection of the fifth sub-electrode overlaps with an orthographic projection of the first pixel unit, and an orthographic projection of the sixth sub-electrode overlaps with an orthographic projection of the second pixel unit; in the second state, a voltage difference V3 between the fifth sub-electrode and the first electrode is greater than or equal to a voltage difference V4 between the sixth sub-electrode and the first electrode.

22. The display panel according to claim 20, further comprising:
a pixel electrode layer, comprising a plurality of pixel electrodes, wherein each pixel electrode of the plurality of pixel electrodes corresponds to a respective pixel unit of the plurality of pixel units,
wherein the viewing angle controller further comprises:
a first electrode, arranged on a side of the first liquid crystal layer facing the first substrate; and
a second electrode, arranged on a side of the first liquid crystal layer facing the second substrate, wherein:
the pixel electrode layer is arranged on a side of the first substrate away from the second substrate, and the plurality of pixel electrodes are multiplexed as the first electrode; or
the pixel electrode layer is arranged on a side of the second substrate away from the first substrate, and the plurality of pixel electrodes are multiplexed as the second electrode.

23. A display device, comprising the display panel, wherein the display panel comprises a viewing angle controller comprising at least one liquid crystal controlling box, and the at least one liquid crystal controlling box comprises a first liquid crystal controlling box, the first liquid crystal controlling box comprises:
a first substrate;
a second substrate, arranged opposite to the first substrate; and
a first liquid crystal layer, arranged between the first substrate and the second substrate, wherein:
the first liquid crystal controlling box is configured to operate in a first state or in a second state;
a transmittance of the first liquid crystal controlling box with respect to a first light in the second state is less than one or both of:
a transmittance of the first liquid crystal controlling box with respect to the first light in the first state, and a transmittance of the first liquid crystal controlling box with respect to a second light in the second state;
wherein an incident angle of the first light at a surface of the first liquid crystal controlling box is greater than an incident angle of the second light at a surface of the first liquid crystal controlling box,
or an inclination of the first light relative to a front-viewing direction of the viewing angle controller is greater than an inclination of the second light relative to the front-viewing direction of the viewing angle controller.
